(19) United States
(12) Patent Application Publication
(10) Pub. No.: US 2011/0046978 A1
(43) Pub. Date: Feb. 24, 2011

(54) DATABASE DRIVEN RULE BASED HEALTHCARE

(75) Inventors: Evian Gordon, New South Wales (AU); Lea Williams, New South Wales (AU)

Correspondence Address: BANNER & WITCOFF, LTD., TEN SOUTH WACKER DRIVE, SUITE 3000, CHICAGO, IL, 60606, US

(73) Assignee: BRC IP PTY LTD, Ultimo, New South Wales (AU)

(21) Appl. No.: 12/922,161

(22) PCT Filed: Mar. 12, 2009
(86) PCT No.: PCT/AU09/00292

§ 371 Date: Sep. 10, 2010

(30) Foreign Application Priority Data
Mar. 12, 2008 (AU) 2008901222

(51) Int. Cl. G06Q 50/00; G06Q 90/00

(52) U.S. Cl. 705/2; 705/500

(57) ABSTRACT

A method is disclosed for rule based healthcare for use in the treatment of a patient. The method includes (a) providing a storage means for storing data indicative of a plurality of decision states, (b) presenting at least one query associated with a decision state, (c) receiving a corresponding at least one response to said at least one query, (d) comparing said response to a plurality of predefined responses ranges for selecting a new query associated with a new decision state, (e) transitioning to the new decision state, and (f) repeating steps (b) through (e) until a terminating decision state is reached.

### FIELD OF THE INVENTION

The present invention relates to healthcare and in particular to rule based healthcare.

The invention has been developed primarily for use in database driven rule based healthcare and will be described hereinafter with reference to this application. However, it will be appreciated that the invention is not limited to this particular field of use.

### BACKGROUND OF THE INVENTION

Any discussion of prior art throughout the specification should in no way be considered as an admission that such prior art is widely known or forms part of the common general knowledge in the field.

The medical treatment of a number of cerebral disorders includes a high level of variance and uncertainty due to imperfect information. It is therefore desirable to provide a more probabilistically certain healthcare regime for such disorders so as to provide for improved healthcare outcomes.

### OBJECT OF THE INVENTION

It is an object of the present invention to overcome or ameliorate at least one of the disadvantages of the prior art, or to provide a useful alternative.

It is an object of the invention in its preferred form to provide a system and method for providing rule based healthcare.

### SUMMARY OF THE INVENTION

In accordance with a first aspect of the present invention, there is provided a method for rule based healthcare for use in the treatment of a patient, the method can comprise the steps of: (a) providing a storage means for storing data indicative of a plurality of decision states; (b) presenting at least one query associated with a decision state; (c) receiving a corresponding at least one response to the at least one query; (d) comparing the response to a plurality of predefined responses ranges for selecting a new query associated with a new decision state; (e) transitioning to the new decision state (f) repeating steps (b) through (e) until a terminating decision state is reached.

In the method, the data indicative of a plurality of decision states can be in the form of a decision tree. The method can also preferably include the step of outputting data indicative of a treatment associated with the final decision state. Further, the step (e) further preferably can include outputting data indicative of a treatment associated with that decision state. The method can be for the treatment of depression or anxiety in the patient.

The queries can include the assessment: Negativity; Response; Impulsivity; Experienced Depression; Experienced Anxiety and/or stress; Cognitive Dysfunction; Emotion Recognition; Social Cognition; and Substance Use.

In accordance with a further aspect of the present invention, there is provided a method of rule based healthcare for use in the treatment of a patient, wherein a predetermined treatment is selected in association with responses to a plurality of predefined queries, wherein the responses define a selected permutation and associated the treatment.

In accordance with a further aspect of the present invention, there is provided a system for quantitative behavioural health management of a patient, the system comprising a processor adapted to perform the method.

In accordance with a further aspect of the present invention, there is provided a system for quantitative behavioural health management of a patient, the system comprising (a) a memory device including a data indicative of a plurality of predefined decision states; (b) output means for displaying a query associated with a current decision state; (c) input means for entering response data indicative of a predetermined plurality responses; (d) a processing means for transition to a new decision state according to the response data and the current decision state; wherein the processing means outputs a predetermined treatment associated with a final decision state.

### BRIEF DESCRIPTION OF THE DRAWINGS

A preferred embodiment of the invention will now be described, by way of example only, with reference to the accompanying drawings in which:

FIG. 1 is pictorial representation of a decision tree;

FIG. 2 is a flowchart of queries to be assessed an embodiment of the present invention;

FIG. 3 is a flowchart similar to FIG. 2, showing possible branches of the decision tree; and

FIG. 4 is a flowchart representation of an embodiment of the present invention.

### PREFERRED EMBODIMENT OF THE INVENTION

An embodiment, by way of example only, provides a decision tree (‘stepped’) framework (or model) for increasing the reliability and thus precision of decision-making in health management settings. It is applied to indicators of severity and treatment options in relation to depression and anxiety or other psychiatric conditions. It is not designed to provide a diagnostic test for these conditions. Rather, the goal is to identify those individuals most at risk and, from their combination of indicators, most likely to benefit from a particular treatment option.

In overview, the decision tree is a rule-based system for probabilistic support in decision-making in connection with the treatment of a patient having, or believed to have, a psychiatric disorder such as depression, anxiety or ADHD. The preferred embodiment is implemented on a computer system such that it is automated and that it may be delivered via the Internet or other computer network, preferably via the world wide web or other protocol accessible via a network.

The embodiment is designed to be regularly updated as the information is further validated in a tight feedback loop.

The utilisation of a brain testing and monitoring feedback loop provides a more statistically valid standardized healthcare system than has been previously possible. The brain testing and monitoring feedback loop leads to a healthcare methodology. The rules provided hereinafter seek to provide a better healthcare regime of treatment of particular individuals and provide the ability to stream people into the right potential intervention and treatment class. The resulting rules thereby provide a quantitative rule based behavioural management system.

While the discussion of the preferred embodiment includes references to “rules”, this term should not necessarily be taken in an entirely prescriptive sense. Rather, as will be clear to the skilled addressee in light of the specification, at least some of the rules (particularly those relating to outcomes) are intended to provide probabilistic guidance in connection with the treatment of a patient.

The preferred embodiment has particular application in any brain related condition and provides an illustration of a rule based health care system. The rules themselves can be derived and refined from treatment based monitoring of subjects. By utilising Brain based monitoring tools in a tight feedback loop, it is possible to provide overall treatments in an individualised manner on a per patient basis. The derived rules themselves can be subject to continual refinement through group subject testing.

The rules can be applied wherever the brain condition has an effect on subject treatment. For example, cancer or heart patients are often prone to depression or the like as a side effect of their condition and the rules have application in such treatments.

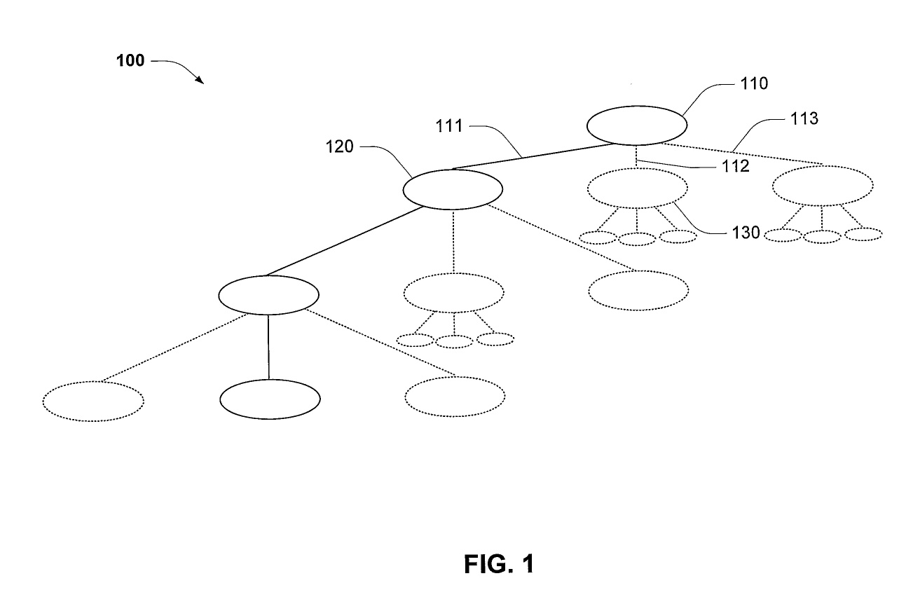

Referring to FIG. 1, the decision tree 100 can be represented as a plurality of nodes (for example 110, 120 and 130). Each node represents a state. Each state can have an output and has decision that must be met for selecting, and progressing down, a branch of the decision tree. For example, from node 110, one of three conditions must be satisfied for transitioning along the decision tree, along branch 111,112 or 113. Selecting branch 111 results in raising state 120, from where further decisions can be made.

A system and method for quantitative behavioural health management is proposed. This provides a stepped model for personalized health care.

It would be appreciated that an embodiment provides a method of drawing on a combination of database findings and scientific literature to generate rules to help stream people to the best possible solutions. A detailed specification of rules has been provided by way of example for the treatment of Depression and Anxiety. It would be further appreciated that the above embodiments are provided by way of example only and these systems and methods can be adapted for the treatment of other disorders.

In an embodiment, the indicators can be derived from objective measures, acquired using fully standardized computerized assessments. These measures are known as ‘general and social cognition’ measures. It has been established in the scientific literature that these measures provide a sound predictor of how individuals will fare in the real world, and their level of associated dysfunction. In addition, these measures have been used to show specific responses to different types of treatment.

The preferred embodiments have been constructed as a result of tests carried out by carrying out computer-based and or web-based cognitive test batteries, which are sensitive to errors of omission and commission, executive function deficits and can report a variety of cognitive impairments, including spatial short-term memory, spatial working memory, set-shifting ability, planning ability, spatial recognition memory, delayed matching to sample, and pattern recognition memory. The Test batteries are available from the Brain Resource Company and the system is as described in U.S. patent application Ser. No. 11/091,048 (Publication Number 20050273017) entitled “Collective Brain Measurement System and Method”, the contents of which are hereby incorporated by cross reference. Although, other standardized Platforms could be utilized.

The system aforementioned has been utilised to establish a stepped model of treatment of ADHD disorders. The example stepped model has been developed using the following lines of evidence:
1. Level I, evidence (at least one randomized-controlled trial)
2. Level II or Level III evidence (well-conducted clinical studies, or extrapolation from Level I). This evidence includes data from the specific measures and indicators included in the decision trees.
3. Level IV evidence (expert committee reports or opinions and/or clinical experience of respected authorities)
4. Recommenced good practice based on clinical experience of the Brain Resource development group

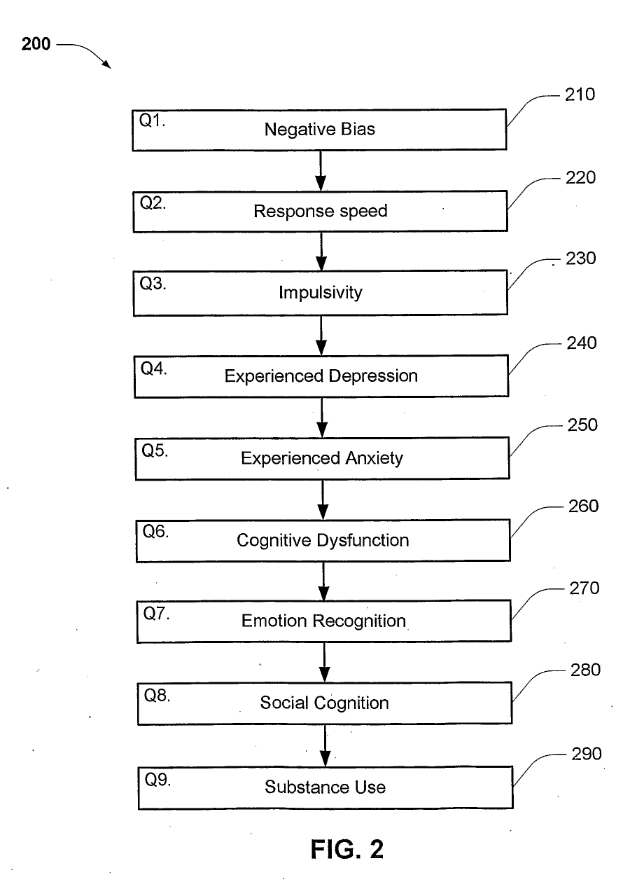

The indicators and the principles from which the lines of evidence form the basis of the decision paths are described below. In summary, by way of example only, the indicators include the following (as best shown in FIG. 2):
1. Negativity Bias 210: Used to as the indicator for initial alert status. The highest alert is identified as a medical consult, whereby to monitor within six weeks.
2. Response Speed 220: Used to stream to a depression decision tree, given its importance to determining severity and treatment in depression.
3. Impulsivity 230: Used to stream to an anxiety decision tree, given its importance in distinguishing anxiety-related features separately from depression.
4. Experienced Depression 240:
5. Experienced Anxiety and/or stress 250:
6. Cognitive Dysfunction 260: If other indicators of cognitive dysfunction are present, these Cognitive Dysfunctions are used to stream for augmentation strategies, given they are largely common to depression and anxiety features.
7. Emotion Recognition 270: This indicator helps provide support for streaming into different treatments.
8. Social Cognition 280: The other social cognition indicators (including social skills and emotional resilience) are used to determine the need for additional attention for these areas.
9. Substance Use 290: Similarly, substance use items are used to determine need for additional attention for these areas when at harmful levels.

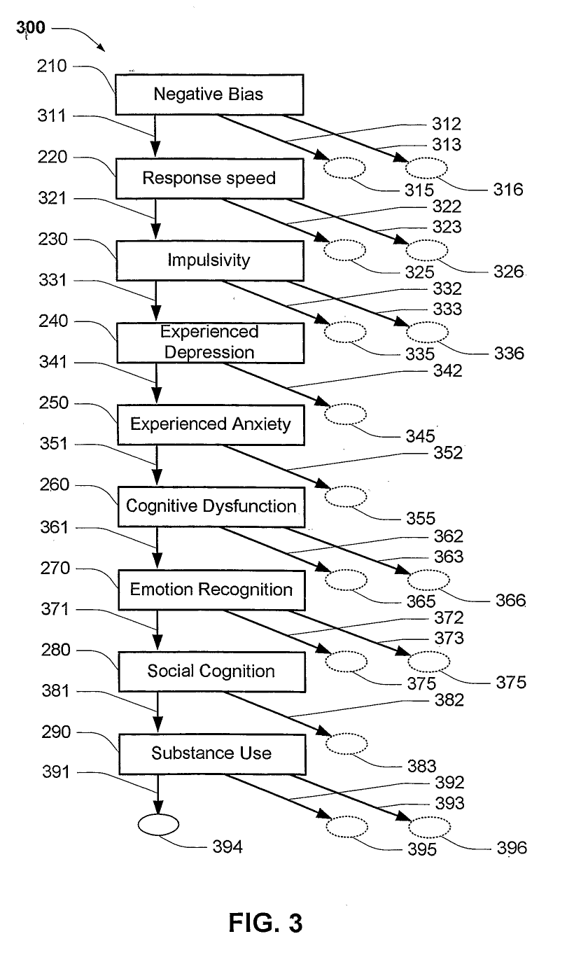

Each query (or representative question) can have a plurality of predefined answers. In this example, referring to FIG. 3, the queries can define a decision tree 300. In this decision tree,
Negative Bias 210, is provided with branches indicative of the Negative Bias being in deficit 311, borderline 312 and Average/Superior 313. This can result in the decision tree transitioning to a state 220, 315 and 316 respectively.
Response Speed 220, is provided with branches indicative of the Response Speed being in deficit 321, borderline 322 and Average/Superior 323. This can result in the decision tree transitioning to a state 230, 325 and 326 respectively.
Impulsivity 230, is provided with branches indicative of the impulsivity being in deficit 331, borderline 332 and Average/Superior 333. This can result in the decision tree transitioning to a state 240, 335 and 336 respectively.
Experienced depression 240, is provided with branches indicative of experienced depression being in moderate to extremely severe 341 and mild to normal 342. This can result in the decision tree transitioning to a state 250 and 345 respectively.
Experienced anxiety/stress 250, is provided with branches indicative of experienced anxiety/stress being in moderate to extremely severe 351 and mild to normal 352. This can result in the decision tree transitioning to a state 260 and 355 respectively.
Cognitive markers 260, is provided with branches indicative of the cognitive markers being in deficit 361, borderline 362 and Average/Superior 363. This can result in the decision tree transitioning to a state 270, 365 and 366 respectively.
Emotional recognition markers 270, is provided with branches indicative of the emotional recognition markers being in deficit 371, borderline 372 and Average/Superior 373. This can result in the decision tree transitioning to a state 280, 375 and 376 respectively.
Social cognitive markers 280, is provided with branches indicative of the social cognitive markers being in moderate to deficit on one or more 381 and not deficit 382. This can result in the decision tree transitioning to a state 290 and 385 respectively.
Substance usage 290, is provided with branches indicative of the substance usage being alcohol 391, other drug 392 and NIL 393. This can result in the decision tree transitioning to a state 394, 395 and 396 respectively.

After traversing the decision tree to the end of a branch, a report can be generated.

### Example Embodiment

The following is an example embodiment, which can be used in the treatment of depression and anxiety.

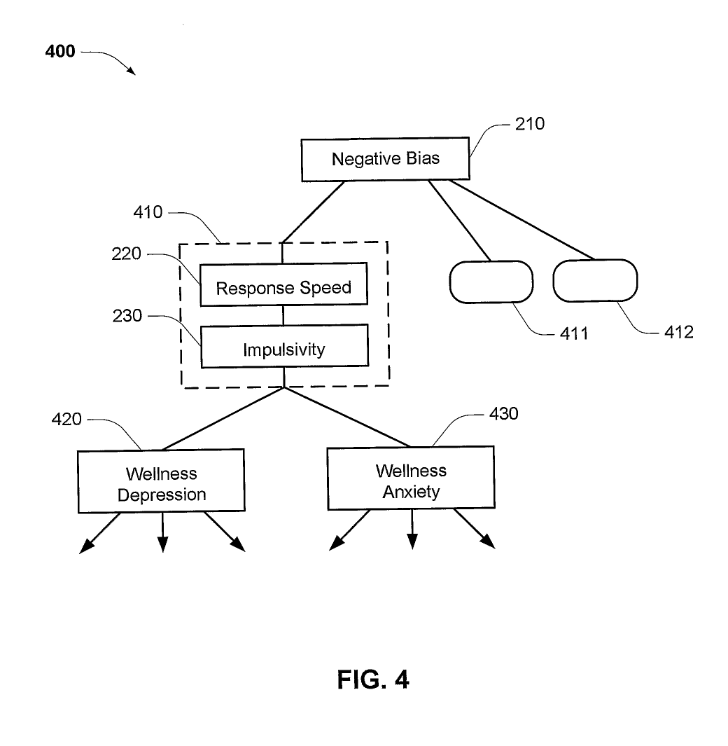

Referring to FIG. 4, in an embodiment 400, the level of negative bias is assessed first.
Step 1 410 is commenced if the negative bias is in deficit.
Step 2 411 is commenced if the negative bias is borderline.
Step 3 412 is commenced if the negative bias is in average and/or superior.

It would be appreciated that the remainder of the decision tree it commenced once the negative bias level is confirmed and step 1 410, step 2 411 or step 3 412 is selected. The remaining portions of the decision tree are discussed below. In this embodiment, only the situation in which negative bias is in deficit is considered.

Referring to FIG. 4, once the negative bias is determined to be in deficit (Query Q.1), a further portion (or branch) of the decision tree is used to next determine “Wellness Depression” or “Wellness Anxiety”. In particular, response speed 220 and impulsivity 230 are used when determining “Wellness Depression” (e.g. 420) or “Wellness Anxiety” (e.g. 420), as represented in the following example decision table.

Response Speed and Impulsivity are determined or identified and the decision tree progresses to a relevant portion relating to Wellness Depression or Wellness Anxiety, as indicated represented by the following decision table.

Once the Response Speed and Impulsivity are assessed, the relevant Depression or Anxiety markers decision tree can be determined. For example, if Response speed is in deficit, go to Wellness Depression markers decision tree (note, these is not a diagnostic separation, but one driver by prominence of markers)

| Q1. | Q2. | | | |
|---|---|---|---|---|
| Negativity | Response | | Q3. | |
| Bias | Speed | | Impulsivity | DECISION TREE |
| Deficit | Deficit | | Deficit | Wellness Depression |
| | | | Borderline | Wellness Depression |
| | | | Average/ | Wellness Depression |
| | | | Superior | |
| | Borderline | | Deficit | Wellness Anxiety |
| | | | Borderline | Wellness Depression |
| | | | Average/ | Wellness Depression |
| | | | Superior | |
| | Average/ | Superior | Deficit | Wellness Anxiety |
| | Superior | | Borderline | Wellness Anxiety |
| | | | Average/ | Wellness Depression |
| | | | Superior | |

### Wellness Depression Decision Tree

The portion of the decision tree associated Wellness depression for Q1—“negative bias” in deficit is further divided into branches on the basis of Q2—“response speed” and Q3—“impulsivity”, as described below.

It would be appreciated that the wellness decision tree for depression covers the following combinations of
Negativity Bias Deficit with Response Speed Deficit, and Impulsivity Deficit to Average/Superior
Negativity Bias Deficit with Response Speed Borderline, and Impulsivity Borderline to Average/Superior
Negativity Bias Deficit with Response Speed Average/Superior, and Impulsivity Average/Superior

| Q1. Negativity | Q2. Response | | | |
|---|---|---|---|---|
| Bias | Speed | | Q3. Impulsivity | DECISION TREE |
| Deficit | Deficit | | Deficit | Wellness Depression |
| | | | Borderline | Wellness Depression |
| | | | Average/Superior | Wellness Depression |
| | Borderline | | Deficit | |
| | | | Borderline | Wellness Depression |
| | | | Average/Superior | Wellness Depression |
| | Average | Superior | Deficit | |
| | | | Borderline | |
| | | | Average/Superior | Wellness Depression |

Confirmation from Experienced Mood can then assessed in the form (Q4) Experienced Depression and (Q5) Experienced Anxiety/Stress. The outcome of which can be summarised in the following table. The two columns “Rationale for Alert and primary solutions indicated” and “Text in Report” are used to determine output from the decision tree.

| | Q4. | | |
|---|---|---|---|
| | Experienced | | |
| | Depression/ | | |
| Q2, Response | Q5. | Rationale for Alert and primary | |
| Speed/ | Experienced | solutions indicated | |
| Q3. | Anxiety/ | (Decision tree for Q1, Q2 vs Q3, Q4. | |
| Impulsivity | Stress | & Q5) | Text in Report |
| Q2 Deficit | Q4 Moderate | “Wellness Depression 1” | High Alert. |
| Q3 Deficit to | to Extremely | Q1. Deficit Negativity Bias is High | WellnessCoach- |
| Average/ | Severe | Alert | Depression, |
| Superior | Q5 Moderate | Self-Solutions indicated for | LiveAndWork |
| | to Extremely | Negativity bias (Ref B1-B6, B24, | Well for Stress. |
| | Severe | B25) | |
| | | Q2, Q3. Deficit slowing: - stream to | |
| | | depression (Ref B13, B14) | |
| | | Q4, Q5 plus moderate-severe | |
| | | depression and moderate-severe | |
| | | anxiety features. Confirms self- | |
| | | solutions. (Ref B15 B7) | |
| | | Q2 + Q4 + Q5 Suggest following | |
| | | treatment solutions (carried through | |
| | | to confirmation from 5 to 8, in Tables | |
| | | D, E & F). | |
| | | b. Medication. Slowing with mixed | |
| | | severe presentation indicates | |
| | | compound neurotransmitter action | |
| | | needed. Implicates SNRI, TCA if | |
| | | non-response with repeat episodes. | |
| | | c. Adjunct CBT once positive drug | |
| | | response and/or slowing improved | |
| | | (Ref B8, B9, A2, A3) | |
| | | Go to Q6. Wellness Depression 1 | |
| | Q4 Moderate | “Wellness Depression 2” | High Alert |
| | to Extremely | Q1. Deficit Negativity Bias = High | WellnessCoach- |
| | Severe | Alert (Ref B1-B6, B24, B25) | Depression. |
| | Q5 | Self-Solutions indicated for | LiveAndWork |
| | Mild/Normal | Negativity bias | Well for Stress |
| | | Q2, Q3. Deficit slowing - stream to | |
| | | depression (Ref B13, B14) | |
| | | Q4, Q5. plus moderate-severe | |
| | | depression and low anxiety features. | |
| | | Confirms self-solutions (Ref B15, | |
| | | B7) | |
| | | Q2, Q4, Q5 suggest following | |
| | | treatment solutions (carried through | |
| | | to confirmation from 5 to 8, in Tables | |
| | | D, E & F). | |
| | | b. Medication. Slowing with mixed | |
| | | severe presentation indicates | |
| | | compound neurotransmitter action | |
| | | needed. Implicates SNRI, TCA if | |
| | | non-response with repeat episodes. | |
| | | c. Adjunct CBT once positive drug | |
| | | response and/or slowing improved | |
| | | (Ref B8, B9) | |
| | | Go to Q6. Wellness Depression 2 | |
| | Q4 | “Wellness Depression 3” | High Alert. |
| | Mild/Normal | Q1. Deficit Negativity Bias = High | WellnessCoach- |
| | Q5Moderate | Alert | Depression. |
| | to | Self-Solutions indicated for | LiveAndWork |
| | Extremely | Negativity bias (Ref B1-B6, | Well for Stress |
| | Severe | BB24, B25) | |
| | | Q2, Q3.. Deficit slowing - stream to | |
| | | depression: (Ref B13, B14) | |
| | | Q4, Q5. plus low depression and | |
| | | moderate-severe anxiety features. | |
| | | (Ref B15) | |
| | | Q2, Q4, Q5 suggest following | |
| | | treatment solutions (carried through | |
| | | to confirmation from 5 to 8, in Tables | |
| | | D, E F). | |
| | | b. Medication. Slowing with anxiety | |
| | | presentation indicates SSRI, with | |
| | | SNRI if non-response. | |
| | | c. Adjunct CBT once positive drug | |
| | | response and/or slowing improved | |
| | | (Ref B8, B9, B7, A2, A3) | |
| | | Go to Q6. Wellness Depression 3 | |
| | Q4 | “Wellness Depression 4” | High Alert. |
| | Mild/Normal | Q1. Deficit Negativity Bias = High | WellnessCoach- |
| | Q5 | Alert | Depression. |
| | Mild/Normal | Self-Solutions indicated for | LiveAndWork |
| | | Negativity bias (Ref B1-B6, B24, | Well for Stress |
| | | B25) | |
| | | Q2, Q3 Deficit slowing - stream to | |
| | | depression. (Ref B13, B14) | |
| | | Q4, Q5. Slowing with low depression | |
| | | and low anxiety features. (Ref B15, | |
| | | B7) | |
| | | Q2, Q4, Q5 suggest following | |
| | | treatment solutions (carried through | |
| | | to confirmation from 5 to 8, in Tables | |
| | | D, E F). | |
| | | b. Inconsistency between markers | |
| | | and experienced mood. Screen for | |
| | | other potential contributing factors; | |
| | | a. personality disorder, b. organic | |
| | | cause, c. other medication effects. | |
| | | Self-solutions for deficit negativity | |
| | | bias | |
| | | (ref C1) | |
| | | Go to Q6. Wellness Depression 4 | |
| Q2 Borderline | Q4 Moderate | “Wellness Depression 5” | High Alert. |
| Q3 Deficit to | to | Q1. Deficit Negativity Bias = High | WellnessCoach- |
| Average/ | Extremely | Alert | Depression, |
| Superior | Severe | Self-Solutions indicated for | LiveAndWork |
| | Q5 Moderate | Negativity bias (Ref B1-B6, B24, | Well for Stress |
| | to | B25) | |
| | Extremely | Q2, Q3. Borderline slowing - stream | |
| | Severe | to depression. (Ref B13, B14) | |
| | | Q4, Q5 Slowing with moderate- | |
| | | severe depression and moderate- | |
| | | severe anxiety features. Confirms | |
| | | self-solutions. (Ref B15, B7) | |
| | | Q2, Q4, Q5 suggest following | |
| | | treatment solutions (carried through | |
| | | to confirmation from 5 to 8, in Tables | |
| | | D, E F). | |
| | | b. Medication. Slowing with mixed | |
| | | severe presentation indicates | |
| | | compound neurotransmitter action | |
| | | needed. Implicates SNRI, TCA if | |
| | | non-response with repeat episodes. | |
| | | c. Adjunct CBT once positive drug | |
| | | response and/or slowing improved | |
| | | (Ref B8, B9, A2, A3) | |
| | | Go to Q6. Wellness Depression 5 | |
| | Q4 Moderate | “Wellness Depression 6” | High Alert |
| | to Extremely | Q1. Deficit Negativity Bias = High | WellnessCoach- |
| | Severe | Alert | Depression, |
| | Q5 | Self-Solutions indicated for | LiveAndWork |
| | Mild/Normal | Negativity bias (Ref B1-B6, B24, | Well for Stress |
| | | B25) | |
| | | Q2, Q3 Borderline slowing - stream | |
| | | to depression. (Ref B13, B14) | |
| | | Q4, Q5,. Slowing with moderate- | |
| | | severe depression and low anxiety | |
| | | features. Confirms Self-Solutions. | |
| | | (Ref B15, B7) | |
| | | Q2, Q4, Q5 suggest following | |
| | | treatment solutions (carried through | |
| | | to confirmation from 5 to 8, in Tables | |
| | | D, E F). | |
| | | b. Medication. Slowing with mixed | |
| | | severe presentation indicates | |
| | | compound neurotransmitter action | |
| | | needed. Implicates SNRI, TCA if | |
| | | non-response with repeat episodes. | |
| | | c. Adjunct CBT once positive drug | |
| | | response and/or slowing improved. | |
| | | (Ref B8, B9, A2, A3) | |
| | | Go to Q6. Wellness Depression 6 | |
| | Q4 | “Wellness Depression 7” | High Alert |
| | Mild/Normal | Q1. Deficit Negativity Bias = High | WellnessCoach- |
| | Q5 Moderate | Alert | Depression, |
| | to | Self-solutions for Negativity Bias | LiveAndWork |
| | Extremely | (Ref B1-B6, B24, B25) | Well for Stress |
| | Severe | Q2, Q3 Borderline slowing - stream | |
| | | to depression. (Ref B13, B14) | |
| | | Q4, Q5 plus low depression and | |
| | | moderate-severe anxiety features. | |
| | | Confirm Self-Solutions. (Ref B15, | |
| | | B7) | |
| | | Q2, Q4, Q5 suggest following | |
| | | treatment solutions (carried through | |
| | | to confirmation from 5 to 8, in Tables | |
| | | D, E F). | |
| | | b. Medication. Slowing with anxiety | |
| | | presentation indicates SSRI, with | |
| | | SNRI if non-response. | |
| | | c. Adjunct CBT once positive drug | |
| | | response and/or slowing improved | |
| | | (Ref B8, B9, A2, A3) | |
| | | Go to Q6. Wellness Depression 7 | |
| | Q4 | “Wellness Depression 8” | High Alert |
| | Mild/Normal | Q1. Deficit Negativity Bias = High | WellnessCoach- |
| | Q5 | Alert (Ref B1-B6) | Depression, |
| | Mild/Normal | Self-Solutions indicated for | LiveAndWork |
| | | Negativity bias | Well for Stress |
| | | Q2, Q3. Borderline slowing - stream | |
| | | to depression. (ref B13, B14) | |
| | | Q4, Q5. Slowing with low depression | |
| | | and low anxiety features. | |
| | | Confirm self-solutions (Ref B15,. | |
| | | B7) | |
| | | Q2., Q4, Q5 suggest following | |
| | | treatment solutions (carried through | |
| | | to confirmation from 5 to 8, in Tables | |
| | | D, E & F). | |
| | | b. Inconsistency between markers | |
| | | and experienced mood. Screen for | |
| | | other potential contributing factors; | |
| | | a. personality disorder, b. organic | |
| | | cause, c. other medication effects. | |
| | | Self-solutions for deficit negativity | |
| | | bias | |
| | | (Ref C1) | |
| | | Go to Q6. Wellness Depression 8 | |
| Q2 Average/ | Q4 Moderate | Wellness Depression 9 | High Alert. |
| Superior | to | Q1 Deficit Negativity Bias = High | WellnessCoach- |
| Q3 Average/ | Extremely | Alert (Ref B1-B6, B24, B25) | Depression. |
| Superior | Severe | Self-Solutions for Negativity bias | LiveAndWork |
| | Q5 Moderate | Q2, Q3 Absence of slowing and | Well for Stress |
| | to | impulsivity - stream to depression: | |
| | Extremely | (Ref B13, B14) | |
| | Severe | Q4, Q5 Absence of slowing with | |
| | | moderate-severe depression and | |
| | | moderate-severe anxiety features. | |
| | | Confirm Self-Solutions (Ref B15 B7) | |
| | | Q2, Q4, Q5 suggest following | |
| | | treatment solutions (carried through | |
| | | to confirmation from 5 to 8, in Tables | |
| | | D, E F). | |
| | | b. Medication. Negativity bias with | |
| | | mood suggests possible SSRI. | |
| | | c. Possible adjunct CBT | |
| | | (ref A1, A2, A3) | |
| | | Go to Q6. Wellness Depression 9 | |
| | Q4 Moderate | “Wellness Depression 10” | High Alert. |
| | to Extremely | Q1 Deficit Negativity Bias = High | WellnessCoach- |
| | Severe | Alert (Ref B1-B6, B24, B25) | Depression. |
| | Q5 | Self-Solutions for Negativity bias | LiveAndWork |
| | Mild/Normal | Q2, Q3 Absence of slowing and | Well for Stress |
| | | impulsivity - stream to depression. | |
| | | (Ref B13, B14 | |
| | | Q4, Q5 Absence of slowing with | |
| | | moderate-severe depression and low | |
| | | anxiety features. Confirm Self- | |
| | | Solutions. (Ref B15, B7) | |
| | | Q2, Q4, Q5 suggest following | |
| | | treatment solutions (carried through | |
| | | to confirmation from 5 to 8, in Tables | |
| | | D, E F). | |
| | | b. Medication. Negativity bias with | |
| | | mood suggests possible SSRI. | |
| | | c. Possible adjunct CBT | |
| | | (Ref A1, A2, A3) | |
| | | Go to Q6. Wellness Depression 10 | |
| | Q4 | “Wellness Depression 11” | High Alert. |
| | Mild/Normal | Q1 Deficit Negativity Bias = High | Wellness Coach- |
| | Q5 Moderate | Alert (Ref B1-B6, B24, B25) | Depression. |
| | to | Self-Solutions for Negativity bias | Live And Work |
| | Extremely | Q2, Q3 Absence of slowing and | Well for Stress |
| | Severe | impulsivity - stream to depression. | |
| | | (Ref B13, B14) | |
| | | Q4, Q5 Absence of slowing with low | |
| | | depression and moderate-severe | |
| | | anxiety features. Confirm Self- | |
| | | Solutions. (Ref B7) | |
| | | Q2, Q4, Q5 suggest following | |
| | | treatment solutions (carried through | |
| | | to confirmation from 5 to 8, in Tables | |
| | | D, E F). | |
| | | b. Medication. Negativity bias with | |
| | | anxious mood suggests possible | |
| | | SSRI. | |
| | | c. Possible adjunct CBT | |
| | | (Ref A1, A2, A3) | |
| | | Go to Q6. Wellness Depression 11 | |
| | Q4 | “Wellness Depression 12” | High Alert. |
| | Mild/Normal | Q1. Deficit Negativity Bias = High | Wellness Coach- |
| | Q5 | Alert | Depression. |
| | Mild/Normal | Self-Solutions for Negativity bias | Live And Work |
| | | (Ref B1-B6, B24, B25) | Well for Stress |
| | | Q2, Q3 Absence of slowing and | |
| | | impulsivity - stream to depression | |
| | | (B13, B14) | |
| | | Q4, Q5. Absence of slowing with | |
| | | low depression and low anxiety | |
| | | features. | |
| | | Confirm Self-Solutions. (Ref B7) | |
| | | Q2, Q4, Q5 suggest following | |
| | | treatment solutions (carried through | |
| | | to confirmation from 5 to 8, in Tables | |
| | | D, E F). | |
| | | b. Negativity bias suggests possible | |
| | | adjunct CBT | |
| | | (Ref A2, A3) | |
| | | Go to Q6. Wellness Depression 12 | |

It would be appreciated that other general cognitive susceptibility markers (for example attention-concentration, memory, executive function) can also be assessed. By way of example only, this assessment can be summarised in the following table. Query Q.6—receives input associated with other general cognitive susceptibility markers (for example any one or more of attention-concentration, information processing efficiency, memory, executive function).

| | Q6. Other | | |
|---|---|---|---|
| | General | | |
| | Cognitive | | |
| | Markers: | | |
| | Memory, | | |
| | Executive | | |
| | Function | | |
| | and/or | Additional Solutions for cognitive | Text in Report |
| Wellness | Attention- | dysfunction and confirmation of work | (Accumulated rules |
| Depression | Concentration | incapacity indicated | with addition of Q6.) |
| Wellness | Deficit on at | Q6. Slowing with cognitive deficit - indicates | Work incapacity |
| Depression | least one | work incapacity for ‘planning’ and ‘manual’ | |
| 1 & 2 | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction |
| | | Adjunct CBT for negativity bias and mood, | Adjunct CBT |
| | | given severity of presentation, especially once | following cognitive |
| | | slowing and cognitive deficits have improved. | improvement |
| | | Q2 to Q6 Indicators confirm High Alert - | Medical referral. |
| | | monitor within 6 weeks. Medical referral for | Monitor within 6 |
| | | medication. | weeks |
| | | Report Button rationale: Combined markers | BUTTON: Markers |
| | | consistent with Depressed mood with marked | consistent with |
| | | Slowing and marked Cognitive dysfunction. | Depressed Mood YES |
| | | (Ref B12, B7, A1, B8-B11, A2, A3, B21) | Consistent with |
| | | | Experienced Mood |
| | | | YES |
| | Borderline | Q6. Slowing with cognitive dysfunction - | Work incapacity |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | medication.. | weeks |
| | | Report Button rationale: Combined markers | BUTTON: Markers |
| | | consistent with Depressed mood with marked | consistent with |
| | | Slowing and moderate Cognitive dysfunction. | Depressed Mood YES |
| | | (Ref B12, B7, A2, A3, B21) | Consistent with |
| | | | Experienced Mood |
| | | | YES |
| | Average/ | Q6. Slowing w/o cognitive dysfunction - | Work incapacity, |
| | Superior on | indicates Work incapacity, especially for | especially ‘manual’ |
| | all markers | ‘manual’ settings | settings. |
| | | Consider | |
| | | Adjunct CBT given severity of presentation, | Adjunct CBT |
| | | especially once slowing improved. | following |
| | | Absence of cognitive dysfunction: Screen for | improvement of |
| | | other potential contributors to response | slowing |
| | | slowing: organic/other medications. | Screen for other |
| | | | potential contributors |
| | | | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with marked | consistent with |
| | | Slowing and absence of cognitive dysfunction. | Depressed Mood |
| | | (Ref B12, A2, A3, C1, B21) | YES |
| | | | Consistent with |
| | | | Experienced Mood |
| | | | YES |
| Wellness | Deficit on at | Q6. Slowing with cognitive deficit - indicates | Work incapacity, |
| Depression 3 | least one | work incapacity for ‘planning’ and ‘manual’ | |
| | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction. |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with marked | consistent with |
| | | Slowing and marked Cognitive dysfunction. | Depressed Mood YES |
| | | (Ref B12, B7, A1, B8-B11, A2, A3, B21) | Consistent with |
| | | | Experienced Mood |
| | | | YES |
| | Borderline | Q6. Slowing with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | medication. | weeks |
| | | Report Button rationale: Combined markers | BUTTON: Markers |
| | | consistent with Depressed mood with marked | consistent with |
| | | Slowing and moderate Cognitive dysfunction. | Depressed Mood YES |
| | | (Ref B12, B7, A2, A3, B21) | Consistent with |
| | | | Experienced Mood |
| | | | YES |
| | Average/ | Q6. Slowing w/o cognitive dysfunction - | Work incapacity, |
| | Superior | indicates Work incapacity, especially for | especially ‘manual’ |
| | | ‘manual’ settings | settings, |
| | | Consider | |
| | | Adjunct CBT given severity of presentation, | Adjunct CBT |
| | | especially once slowing improved. | following |
| | | Absence of cognitive dysfunction: Screen for | improvement of |
| | | other potential contributors to response | slowing |
| | | slowing: organic/other medications. | Screen for other |
| | | | potential contributors |
| | | | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with marked | consistent with |
| | | Slowing and absence of cognitive dysfunction. | Depressed Mood YES |
| | | (Ref B12, A2, A3, C1, B21) | Consistent with |
| | | | Experienced Mood |
| | | | YES |
| Wellness | Deficit on at | Q6. Slowing with cognitive deficit - indicates | Work incapacity, |
| Depression 4 | least one | work incapacity for ‘planning’ and ‘manual’ | |
| | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Depressed mood with marked | consistent with |
| | | Slowing and marked Cognitive dysfunction., | Depressed Mood |
| | | but | YES. |
| | | inconsistent with experienced mood. | Consistent with |
| | | Screen for other potential contributors to | Experienced Mood |
| | | cognitive susceptibility markers: organic/other | NO. |
| | | medications. | Screen for other |
| | | (Ref B12,. B7, A1, B8-B11, B21, C1) | potential contributors |
| | | | to cognitive |
| | | | susceptibility markers. |
| | Borderline | Q6. Slowing with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Depressed mood with marked | consistent with |
| | | Slowing and moderate Cognitive dysfunction, | Depressed Mood YES |
| | | but inconsistent with experienced mood. | Consistent with |
| | | Screen for other potential contributors to | Experienced Mood |
| | | cognitive susceptibility markers | NO. |
| | | (Ref B12, B7, B21,. C1) | Screen for other |
| | | | potential contributors |
| | | | to cognitive |
| | | | susceptibility markers. |
| | Average/ | Q6. Slowing w/o cognitive dysfunction - | Work incapacity, |
| | Superior | indicates Work incapacity, especially for | especially ‘manual’ |
| | | ‘manual’ settings | settings |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Depressed mood with marked | consistent with |
| | | Slowing and moderate Cognitive dysfunction, | Depressed Mood |
| | | but inconsistent with experienced mood. | YES |
| | | Screen for other potential contributors to | Consistent with |
| | | cognitive susceptibility markers | Experienced Mood |
| | | (ref B12, B21, C1) | NO. |
| | | | Screen for other |
| | | | potential contributors |
| | | | to negativity bias and |
| | | | response slowing. |
| Wellness | Deficit on at | Q6. Slowing with cognitive deficit - indicates | Work incapacity, |
| Depression | least one | work incapacity for ‘planning’ and ‘manual’ | |
| 5 & 6 | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction, |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with | consistent with |
| | | moderate Slowing and marked Cognitive | Depressed Mood YES |
| | | dysfunction. | Consistent with |
| | | (Ref B12, B7, A1, B8-B11, A2, A3, B21) | Experienced Mood |
| | | | YES |
| | Borderline | Q6. Slowing with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | medication.. | weeks |
| | | Report Button rationale: Combined markers | BUTTON: Markers |
| | | consistent with Depressed mood with | consistent with |
| | | moderate Slowing and moderate Cognitive | Depressed Mood YES |
| | | dysfunction. | Consistent with |
| | | (Ref B1, B7, A2, A3, B21) | Experienced Mood |
| | | | YES |
| | Average/ | Q6. Slowing w/o cognitive dysfunction - | Work incapacity, |
| | Superior | indicates Work incapacity, especially for | especially ‘manual’ |
| | | ‘manual’ settings | settings, |
| | | Consider | |
| | | Adjunct CBT given severity of presentation, | Adjunct CBT |
| | | especially once slowing improved. | following |
| | | Absence of cognitive dysfunction: Screen for | improvement of |
| | | other potential contributors to response | slowing |
| | | slowing: organic/other medications. | Screen for other |
| | | | potential contributors |
| | | | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button Rationale: Combined markers | BUTTON: Markers |
| | | consistent with Depressed mood with | consistent with |
| | | moderate Slowing and absence of cognitive | Depressed Mood YES |
| | | dysfunction. | Consistent with |
| | | (Ref B12, A2, A3, C1, B21) | Experienced Mood |
| | | | YES |
| Wellness | Deficit on at | Q6. Slowing with cognitive deficit - indicates | Work incapacity, |
| Depression 7 | least one | work incapacity for ‘planning’ and ‘manual’ | |
| 7 | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction, |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with | consistent with |
| | | moderate Slowing and marked Cognitive | Depressed Mood YES |
| | | dysfunction. | Consistent with |
| | | (Ref B12, B7, A1, B8-B11, A2, A3, B21) | Experienced Mood |
| | | | YES |
| | Borderline | Q6. Slowing with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication.. | weeks |
| | | Report Button rationale: Combined markers | BUTTON: Markers |
| | | consistent with Depressed mood with | consistent with |
| | | moderate Slowing and moderate Cognitive | Depressed Mood YES |
| | | dysfunction. | Consistent with |
| | | (ref B12, B7,. A2, A3, B21) | Experienced Mood |
| | | | YES |
| | Average/ | Q6.. Slowing w/o cognitive dysfunction - | Work incapacity, |
| | Superior | indicates Work incapacity, especially for | especially ‘manual’ |
| | | ‘manual’ settings | settings, |
| | | Consider | |
| | | Adjunct CBT given severity of presentation, | Adjunct CBT |
| | | especially once slowing improved. | following |
| | | Absence of cognitive dysfunction: Screen for | improvement of |
| | | other potential contributors to response | slowing |
| | | slowing: organic/other medications. | Screen for other |
| | | | potential contributors |
| | | | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Depressed mood with | consistent with |
| | | moderate Slowing and absence of cognitive | Depressed Mood |
| | | dysfunction. | YES |
| | | (Ref B12, A2, A3, C1, B21) | Consistent with |
| | | | Experienced Mood |
| | | | YES |
| Wellness | Deficit on at | Q6. Slowing with cognitive deficit - indicates | Work incapacity, |
| Depression 8 | least one | work incapacity for ‘planning’ and ‘manual’ | |
| | marker | settings. | |
| | | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: | BUTTON: Markers |
| | | Combined markers consistent with Depressed | consistent with |
| | | mood with moderate Slowing and marked | Depressed Mood YES. |
| | | Cognitive dysfunction., but | Consistent with |
| | | inconsistent with experienced mood. | Experienced Mood |
| | | Screen for other potential contributors to | NO. |
| | | cognitive susceptibility markers: organic/other | Screen for other |
| | | medications. | potential contributors |
| | | (Ref B12, B7, A1, B8-B11, B21, C1) | to cognitive |
| | | | susceptibility markers. |
| | Borderline | Q6. Slowing with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Depressed mood with | consistent with |
| | | moderate Slowing and moderate Cognitive | Depressed Mood YES |
| | | dysfunction, but inconsistent with experienced | Consistent with |
| | | mood. | Experienced Mood |
| | | Screen for other potential contributors to | NO. |
| | | cognitive susceptibility markers | Screen for other |
| | | (Ref B12, B7,. B21, C1) | potential contributors |
| | | | to cognitive |
| | | | susceptibility markers. |
| | Average/ | Q6. Slowing w/o cognitive dysfunction - | Work incapacity, |
| | Superior | indicates Work incapacity, especially for | especially ‘manual’ |
| | | ‘manual’ settings | settings |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Depressed mood with | consistent with |
| | | moderate slowing but absence of cognitive | Depressed Mood YES |
| | | dysfunction. Screen for other potential | Consistent with |
| | | contributors to negativity bias and response | Experienced Mood |
| | | slowing: organic/other medications. | NO. |
| | | (Ref B12, B21, C1) | Screen for other |
| | | | potential contributors |
| | | | to negativity bias and |
| | | | response slowing. |
| Wellness | Deficit on at | Q6.. Absence of slowing with cognitive | Work incapacity, |
| Depression | least one | deficit - indicates work incapacity. | |
| 9 & 10 | marker | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction, |
| | | Adjunct CBT given severity of presentation, | Adjunct CBT |
| | | especially once slowing and cognitive deficits | following cognitive |
| | | have improved. | improvement |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Depressed mood with marked | consistent with |
| | | Cognitive dysfunction. | Depressed Mood YES |
| | | (Ref B12, B7, A1, B8-B11, A2, A3, B21) | Consistent with |
| | | | Experienced Mood |
| | | | YRS. |
| | Borderline | Q6. Absence of slowing with cognitive | Work incapacity, |
| | on at least | dysfunction - indicates Work incapacity | |
| | one marker, | Consider | Self-solutions |
| | in absence | Self-solutions for cognitive dysfunction. | ‘cognitive gym’. |
| | of Deficit | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation.. | weeks |
| | | Report Button rationale: Combined markers | BUTTON: Markers |
| | | consistent with Depressed mood with | consistent with |
| | | moderate Cognitive dysfunction. | Depressed Mood YES |
| | | (Ref B12, B7, A2, A3, B21) | Consistent with |
| | | | Experienced Mood |
| | | | YES |
| | Average/ | Q6. Absence of slowing w/o cognitive | |
| | Superior | dysfunction - no confirmation of work | |
| | | incapacity. | |
| | | Screen for other potential contributors to | Screen for other |
| | | negativity bias: life events, personality | potential contributors |
| | | | to negativity bias |
| | | Q2 to Q6. Indicators confirm High Alert - | Medical referral. |
| | | monitor within 6 weeks. Medical referral for | Monitor within 8-12 |
| | | evaluation.. | weeks |
| | | Report Button rationale: Combined markers | BUTTON: Markers |
| | | consistent with risk for Depressed mood with | consistent with risk for |
| | | absence of slowing and cognitive dysfunction. | Depressed Mood YES |
| | | (Ref B12, C1, B21) | Consistent with |
| | | | Experienced Mood |
| | | | YES |
| Wellness | Deficit on at | Q6. Absence of slowing with cognitive deficit - | Work incapacity, |
| Depression | least one | indicates work incapacity. | |
| 11 | marker | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction, |
| | | Adjunct CBT given severity of experienced | Adjunct CBT |
| | | mood, especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Depressed mood with absence | consistent with |
| | | of Slowing and marked Cognitive | Depressed Mood YES |
| | | dysfunction. | Consistent with |
| | | (Ref B12, B7, A1, B8-B11, A2, A3, B21) | Experienced Mood |
| | | | YES |
| | Borderline | Q6.. Absence of slowing borderline with | Work incapacity, |
| | on at least | cognitive deficit - indicates work incapacity. | |
| | one marker, | Consider | Self-solutions |
| | in absence | Self-solutions for cognitive dysfunction. | ‘cognitive gym’, |
| | of Deficit | Adjunct CBT given severity of experienced | Adjunct CBT |
| | | mood, especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Depressed mood with absence | consistent with |
| | | of Slowing and moderate Cognitive | Depressed Mood YES |
| | | dysfunction. | Consistent with |
| | | (Ref B12, B7, A2, A3, B21) | Experienced Mood |
| | | | YES |
| | Average/ | Q6. Absence of slowing borderline w/o | |
| | Superior | cognitive deficit - no confirmation of work | |
| | | incapacity. | |
| | | Consider | |
| | | Adjunct CBT given severity of experienced | Adjunct CBT |
| | | mood. | |
| | | Screen for other potential contributors to | Screen for other |
| | | negativity bias: life events, personality | potential contributors |
| | | | to negativity bias |
| | | Q2 to Q6. Indicators confirm less immediate | Medical referral for |
| | | High Alert - monitor within 8-12 weeks. | early intervention. |
| | | Medical referral for early intervention | Monitor within 8-12 |
| | | | weeks |
| | | Report Button rationale: Combined markers | BUTTON: Markers |
| | | consistent with Depressed mood with absence | consistent with risk for |
| | | of Slowing and Cognitive dysfunction. | Depressed Mood YES |
| | | (Ref B12, A2, A3, C1, B21) | Consistent with |
| | | | Experienced Mood |
| | | | YES |
| Wellness | Deficit on at | Q6. Absence of slowing with cognitive deficit - | Work incapacity, |
| Depression | least one | indicates work incapacity. | |
| 12 | marker | Consider | Self-solutions |
| | | Self-solutions for cognitive dysfunction. | ‘cognitive gym’, |
| | | Augmentation for cognitive dysfunction, | Augmentation for |
| | | given severity. | cognitive dysfunction |
| | | Screen for other potential contributors to | Screen for other |
| | | cognitive susceptibility markers: organic/other | potential contributors |
| | | medications. | to cognitive |
| | | | susceptibility markers. |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Depressed mood with absence | consistent with |
| | | of Slowing and marked Cognitive | Depressed Mood YES. |
| | | dysfunction., but | Consistent with |
| | | inconsistent with experienced mood. | Experienced Mood |
| | | (Ref B12, B7, A1, B8-B11, C1, B21) | NO. |
| | Borderline | Q6. Absence of slowing with borderline | Work incapacity, |
| | on at least | cognitive deficit - indicates work incapacity. | |
| | one marker, | Consider | Self-solutions |
| | in absence | Self-solutions for cognitive dysfunction. | ‘cognitive gym’ |
| | of Deficit | Q2 to Q6.. Indicators confirm less immediate | Medical referral for |
| | | High Alert - monitor within 8-12 weeks. | early intervention. |
| | | Medical referral for early intervention | Monitor within 8-12 |
| | | | weeks |
| | | Report Button rationale: Combined markers | BUTTON: Markers |
| | | consistent with Depressed mood with absence | consistent with |
| | | of Slowing and moderate Cognitive | Depressed Mood YES |
| | | dysfunction, but inconsistent with experienced | Consistent with |
| | | mood. Screen for other potential contributors | Experienced Mood |
| | | to cognitive susceptibility markers | NO. |
| | | (Ref B12, B7, B21, C1) | Screen for other |
| | | | potential contributors |
| | | | to cognitive |
| | | | susceptibility markers. |
| | Average/ | Q6. Absence of slowing and cognitive deficit - | Screen for other |
| | Superior | no confirmation of work incapacity. | potential contributors |
| | | Screen for other potential contributors to | to negativity bias. |
| | | negativity bias: life events, personality | |
| | | Q2 to Q6.. Indicators confirm less immediate | Medical referral for |
| | | High Alert - monitor within 8-12 weeks. | early intervention. |
| | | Medical referral for early intervention | Monitor within 8-12 |
| | | | weeks |
| | | Report Button rationale: Combined markers | BUTTON: Markers |
| | | consistent with risk for Depressed mood with | consistent with risk for |
| | | absence of slowing and cognitive dysfunction. | Depressed Mood YES |
| | | (Ref B12, C1, B21) | Consistent with |
| | | | Experienced Mood |
| | | | NO. |

By way of example only, if depression 1 had borderline for Other General Cognitive markers, work incapacity and self-solutions ‘cognitive gym’ are indicated in addition to Indicators in C. These additional indicators are added to Report. The additional information from these markers also provides confirmation of consistency (or otherwise) with Depressed Mood and Experienced Mood.

Confirmation from Emotion Recognition marker can be assessed. By way of example this assessment can be summarised in the following table.

| | Q7. | | |
|---|---|---|---|
| | Emotion | | Text in Report |
| Wellness | Recognition | | (Add from rules |
| Depression | Marker | Supporting indicators | for Q7) |
| Wellness | Deficit | Q7. Specific slowing of Negative emotion, | Higher dose SNRI |
| Depression | | especially sadness, happiness. | or TCA if non- |
| 1 & 2 | | Support for a. Higher dose SNRI or TCA if non- | response, SNDRI or |
| | | response, b. SNDRI or MAOI if non-response. | MAOI if non- |
| | | Go to Q8 | response, |
| | | (Ref B17, B18, B19, A4) | |
| | Borderline | Q7.. Specific slowing of Negative emotion, | Higher dose SNRI |
| | | especially sadness, happiness. Go to Q8 | or TCA if non- |
| | | (Ref B17, B18, B19) | response, SNDRI or |
| | | | MAOI if non- |
| | | | response |
| | Average/ | Go to Q8. | |
| | Superior | | |
| Wellness | Deficit | Q7. Specific slowing of Negative emotion, | SSRI, SNRI if non- |
| Depression 3 | | especially sadness, happiness. Given greater | response |
| | | experienced anxiety than depression, support for | |
| | | a. SSRI, b. SNRI if non-response. Go to Q8 | |
| | | (Ref B17, B18, B29, A4, PSYCHOMOTOR VS) | |
| | Borderline | Q7. Specific slowing of Negative emotion, | SSRI, SNRI if non- |
| | | especially sadness, happiness. Support for a. | response |
| | | SSRI, b. SNRI if non-response. Go to Q8 | |
| | | (Ref B17, B18, B19 A4) | |
| | Average/ | Go to Q8 | |
| | Superior | | |
| Wellness | Deficit | Q7. Specific slowing of Negative emotion, | SSRI if compatible |
| Depression 4 | | especially sadness, happiness. a. SSRI may be | with screen results |
| | | indicated. Go to Q8 | |
| | | (Ref B17, B18, B19, A4) | |
| | Borderline | Q7. Specific slowing of Negative emotion, | SSRI if compatible |
| | | especially sadness, happiness. SSRI may be | with screen results |
| | | indicated. Go to Q8 | |
| | | (Ref B17, B18, B19 A4) | |
| | Average/ | Go to Q8 | |
| | Superior | | |
| Wellness | Deficit | Q7. Specific slowing of Negative emotion, | Higher dose SNRI |
| Depression | | especially sadness, happiness. | or TCA if non- |
| 5 & 6 | | Support for a. Higher dose SNR or TCA if non- | response, SNDRI or |
| | | response, b. SNDRI or MAOI if non-response. | MAOI if non- |
| | | Go to Q8 | response, |
| | | (Ref B17, B18, B19 A4) | |
| | Borderline | Q7. Specific slowing of Negative emotion, | Higher dose SNRI |
| | | especially sadness, happiness. Go to Q8 | or TCA if non- |
| | | (Ref B17, B18, B19 A4) | response, SNDRI or |
| | | | MAOI if non- |
| | | | response |
| | Average/ | Go to Q8. | |
| | Superior | | |
| Wellness | Deficit | Q7. Specific slowing of Negative emotion, | SSRI, SNRI if non- |
| Depression 7 | | especially sadness, happiness. Given greater | response |
| | | experienced anxiety than depression, support for | |
| | | a. SSRI, b. SNRI if non-response. Go to Q8 | |
| | | (Ref B17, B18, B19 A4) | |
| | Borderline | Q7. Specific slowing of Negative emotion, | SSRI, SNRI if non- |
| | | especially sadness, happiness. Given greater | response |
| | | experienced anxiety than depression, support for | |
| | | a. SSRI, b. SNRI if non-response. Go to Q8 | |
| | | (Ref B17, B18, B19 A4) | |
| | Average/ | Go to Q8 | |
| | Superior | | |
| Wellness | Deficit | Q7. Specific slowing of Negative emotion, | SSRI if compatible |
| Depression 8 | | especially sadness, happiness. a. SSRI may be | with screen results |
| | | indicated. Go to Q8 | |
| | | (Ref B17, B18, B19 A4) | |
| | Borderline | Q7. Specific slowing of Negative emotion, | SSRI if compatible |
| | | especially sadness, happiness. SSRI may be | with screen results |
| | | indicated. Go to Q8 | |
| | | (Ref B17, B18, B19 A4) | |
| | Average/ | Go to Q8 | |
| | Superior | | |
| Wellness | Deficit | Q7. Specific slowing of Negative emotion, | SSRI |
| Depression | | especially fear, anger happiness. a. SSRI may be | |
| 9 & 10 | | indicated. Go to Q8 | |
| | | (Ref B17, B18, B19 A4) | |
| | Borderline | Q7. Specific slowing of Negative emotion, | SSRI |
| | | especially fear, anger. SSRI may be indicated. | |
| | | Go to Q8 | |
| | | (Ref B17, B18, B19 A4) | |
| | Average/ | Go to Q8 | |
| | Superior | | |
| Wellness | Deficit | Q7. Specific slowing of Negative emotion, | SSRI if compatible |
| Depression | | especially sadness, happiness. Given greater | with screen results |
| 11 | | experienced anxiety than depression, consider a. | |
| | | SSRI. Go to Q8 | |
| | | (Ref B17, B18, B19 A4) | |
| | Borderline | Q7. Specific slowing of Negative emotion, | SSRI if compatible |
| | | especially fear, anger. Given greater experienced | with screen results |
| | | anxiety than depression, SSRI may be indicated. | |
| | | Go to Q8 | |
| | | (Ref B17, B18, B19 A4) | |
| | Average/ | Go to Q8 | |
| | Superior | | |
| Wellness | Deficit to | Go to Q8 | |
| Depression | Average/ | | |
| 12 | Superior | | |

Other social cognitive markers and substance use can be assessed. By way of example this assessment can be summarised in the following table. In this example Queries Q. 8 and Q. 9 receive input associated with social cognitive markers and substance use (for example Emotional Resilience/Sociability).

| | Q8. | | | |
|---|---|---|---|---|
| | Other Social | | | |
| | Cognitive | | | |
| | Markers | Q9. | | Text in Report* |
| Wellness | (Emotional | Substance | | (Add from rules for |
| Depression | Resilience/Sociability) | Use | Additional Solutions indicated | Q8 and Q9) |
| Wellness | Deficit on | Alcohol | Q8. Self-solutions for Social | Social Skills |
| Depression | one or more | | Cognition deficit | LiveAndWorkWell |
| 1 to 12 | | | Q9. Harmful Drinking. Self- | Alcohol |
| | | | Solutions plus Referral for Alcohol | Alcohol service |
| | | | service | referral |
| | | | (Ref B7, B22, B23) | |
| | | Other Drug | Q8. Self-solutions for Social | Social Skills |
| | | | Cognition deficit | Drug service referral |
| | | | Q9. Harmful Drug taking. Referral | |
| | | | for Drug service | |
| | | | (Ref B7, B22, B23) | |
| | | No | Q8. Self-solutions for Social | Social Skills |
| | | | Cognition deficit | |
| | | | (Ref B7) | |
| | No Deficit | Alcohol | Q9. Harmful Drinking. Self- | LiveAndWorkWell |
| | | | Solutions plus Referral for Alcohol | Alcohol |
| | | | service | Alcohol service |
| | | | (Ref B22, B23) | referral |
| | | Other Drug | Q9. Harmful Drug taking. Referral | Drug service referral |
| | | | for Drug service | |
| | | | (Ref B22, B23) | |
| | | No | | |

It can be appropriate to report alcohol or other drugs if answering YES to harmful levels as defined by particular queries.

By way of example only if depression 1 also had a social cognition marker deficit and alcohol substance use, then social skills, LiveAndWorkWell Alcohol and Alcohol service referral indicators would apply. These are the final additional indicators added to Report.

This reaches the termination of the particular branch of enquiry for this example embodiment. The wellness anxiety decision tree for this embodiment follows.

### Wellness Anxiety Decision Tree

It would be appreciated that the wellness decision tree for anxiety covers the following combinations of:
Negativity Bias Deficit with Response Speed Borderline, and Impulsivity Deficit
Negativity Bias Deficit with Response Speed Average/Superior, and Impulsivity Deficit or Borderline

| Q1. Negativity | | | | DECISION |
|---|---|---|---|---|
| Bias | Q2. Response Speed | | Q3. Impulsivity | TREE |
| Deficit | Deficit | | Deficit | |
| | | | Borderline | |
| | | | Average/Superior | |
| | Borderline | | Deficit | Go to |
| | | | | Wellness |
| | | | | Anxiety |
| | | | Borderline | |
| | | | Average/Superior | |
| | Average | Superior | Deficit | Go to |
| | | | | Wellness |
| | | | | Anxiety |
| | | | Borderline | Go to |
| | | | | Wellness |
| | | | | Anxiety |
| | | | Average/Superior | |

Confirmation from Experienced Mood can then assessed in the form (Q4) Experienced Depression and (Q5) Experienced Anxiety/Stress. The outcome of which can be summarised in the following table.

| | Q4. | | |
|---|---|---|---|
| | Experienced | | |
| | Depression | Rationale for Alert and primary | |
| Q2. Response | Q5. | solutions indicated | |
| Speed | Experienced | (Decision tree for Q1, Q2 vs Q3, Q4. | |
| Q3. Impulsivity | Anxiety/Stress | & Q5) | Text in Report |
| Q2. Borderline | Q4 Moderate | “Wellness Anxiety 1” | High Alert. |
| Q3 Deficit | to | Q1. Deficit Negativity Bias = High | WellnessCoach- |
| | Extremely | Alert | Depression, |
| | Severe | Self-solutions for negativity bias | LiveAndWork |
| | Q5 Moderate | Q2, Q3. Deficit impulsivity - stream | Well for Stress |
| | to | to Anxiety | |
| | Extremely | Q4, Q5 . . . Impulsivity with moderate- | |
| | Severe | severe anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response | |
| | | Go to Q6. Wellness Anxiety 1 | |
| | | (Ref B1-B6, B24, B25, B15, A2, A3) | |
| | Q4 Moderate | “Wellness Anxiety 2” | High Alert |
| | to Extremely | Q1. Deficit Negativity Bias = High | WellnessCoach- |
| | Severe | Alert | Depression, |
| | Q5 | Self-solutions for negativity bias | LiveAndWork |
| | Mild/Normal | Q2, Q3. Deficit impulsivity - stream | Well for Stress |
| | | to Anxiety | |
| | | Q4, Q5 . . . Impulsivity with moderate- | |
| | | severe anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response | |
| | | Go to Q6. Wellness Anxiety 2 | |
| | | (Ref B1-B6, B24, B25, B15, B7, A2, | |
| | | A3) | |
| | Q4 | “Wellness Anxiety 3” | High Alert |
| | Mild/Normal | Q1. Deficit Negativity Bias = High | WellnessCoach- |
| | Q5 Moderate | Alert | Depression, |
| | to | Self-solutions for negativity bias | LiveAndWork |
| | Extremely | Q2, Q3. Deficit impulsivity - stream | Well for Stress |
| | Severe | to Anxiety | |
| | | Q4, Q5. Impulsivity with moderate- | |
| | | severe anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response | |
| | | Go to Q6. Wellness Anxiety 3 | |
| | | (Ref B1-B6, B15, B7, A2, A3) | |
| | Q4 | “Wellness Anxiety 4” | High Alert |
| | Mild/Normal | Q1. Deficit Negativity Bias = High | WellnessCoach- |
| | Q5 | Alert | Depression, |
| | Mild/Normal | Self-solutions for negativity bias | LiveAndWork |
| | | Q2, Q3. Deficit impulsivity - stream | Well for Stress |
| | | to Anxiety | |
| | | Q4, Q5. Impulsivity with low | |
| | | depression and low anxiety features. | |
| | | Q2, Q4, Q5 suggest following | |
| | | treatment solutions (carried through | |
| | | to confirmation from 5 to 8, in Tables | |
| | | D, E F). | |
| | | Inconsistency between markers and | |
| | | experienced mood. Screen for other | |
| | | potential contributing factors; a. | |
| | | personality disorder, b. organic | |
| | | cause, c. other medication effects. | |
| | | Self-solutions for deficit negativity | |
| | | bias | |
| | | Go to Q6. Wellness Anxiety 4 | |
| | | (Ref B1-B6, B15, B7, C1) | |
| Q2 Average/ | Q4 Moderate | “Wellness Anxiety 5” | High Alert. |
| Superior | to | Q1. Deficit Negativity Bias = High | WellnessCoach- |
| Q3 Deficit | Extremely | Alert | Depression. |
| | Severe | Self-solutions for negativity bias | LiveAndWork |
| | Q5 Moderate | Q2, Q3. Deficit impulsivity - stream | Well for Stress |
| | to | to Anxiety: | |
| | Extremely | Q4, Q5 . . . Impulsivity with moderate- | |
| | Severe | severe anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 5 | |
| | | (Ref B1-B6, B24, B25, B15, A2, A3) | |
| | Q4 Moderate | “Wellness Anxiety 6” | High Alert. |
| | to Extremely | Q1. Deficit Negativity Bias = High | WellnessCoach- |
| | Severe | Alert | Depression. |
| | Q5 | Self-solutions for negativity bias | LiveAndWork |
| | Mild/Normal | Q2, Q3. Deficit impulsivity - stream | Well for Stress |
| | | to Anxiety: | |
| | | Q4, Q5 . . . Impulsivity with low | |
| | | anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 6 | |
| | | (Ref B1-B6, B24, B25, B15, A2, A3) | |
| | Q4 | “Wellness Anxiety 7” | High Alert. |
| | Mild/Normal | Q1. Deficit Negativity Bias = High | WellnessCoach- |
| | Q5 Moderate | Alert | Depression. |
| | to | Self-solutions for negativity bias | LiveAndWork |
| | Extremely | Q2, Q3. Deficit impulsivity - stream | Well for Stress |
| | Severe | to Anxiety: | |
| | | Q4, Q5 . . . Impulsivity with moderate- | |
| | | severe anxiety and low depression | |
| | | features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 7 | |
| | | (Ref B1-B6, B24, B25, B15, A2, A3) | |
| | Q4 | “Wellness Anxiety 8” | High Alert |
| | Mild/Normal | Q1. Deficit Negativity Bias = High | WellnessCoach- |
| | Q5 | Alert | Depression, |
| | Mild/Normal | Self-solutions for negativity bias | LiveAndWork |
| | | Q2, Q3. Deficit impulsivity - stream | Well for Stress |
| | | to Anxiety | |
| | | Q4, Q5. Impulsivity with low | |
| | | depression and low anxiety features. | |
| | | Q2, Q4, Q5 suggest following | |
| | | treatment solutions (carried through | |
| | | to confirmation from 5 to 8, in Tables | |
| | | D, E F). | |
| | | Inconsistency between markers and | |
| | | experienced mood. Screen for other | |
| | | potential contributing factors; a. | |
| | | personality disorder, b. organic | |
| | | cause, c. other medication effects. | |
| | | Self-solutions for deficit negativity | |
| | | bias | |
| | | Go to Q6. Wellness Anxiety 4 | |
| | | (Ref B1-B6, B15, B7, C1) | |
| Q2 Average/ | Q4 Moderate | “Wellness Anxiety 9” | High Alert. |
| Superior | to | Q1. Deficit Negativity Bias = High | WellnessCoach- |
| Q3 Borderline | Extremely | Alert | Depression. |
| | Severe | Self-solutions for negativity bias | LiveAndWork |
| | Q5 Moderate | Q2, Q3. Deficit impulsivity - stream | Well for Stress |
| | to | to Anxiety: | |
| | Extremely | Q4, Q5 . . . Impulsivity with moderate- | |
| | Severe | severe anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 9 | |
| | | (Ref B1-B6, B24, B25, B15, A2, A3) | |
| | Q4 Moderate | “Wellness Anxiety 10” | High Alert. |
| | to Extremely | Q1. Deficit Negativity Bias = High | WellnessCoach- |
| | Severe | Alert | Depression. |
| | Q5 | Self-solutions for negativity bias | LiveAndWork |
| | Mild/Normal | Q2, Q3. Deficit impulsivity - stream | Well for Stress |
| | | to Anxiety: | |
| | | Q4, Q5 . . . Impulsivity with low | |
| | | anxiety and moderate-severe | |
| | | depression features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 10 | |
| | | (Ref B1-B6, B24, B25, B15, A2, A3) | |
| | Q4 | “Wellness Anxiety 11” | High Alert. |
| | Mild/Normal | Q1. Deficit Negativity Bias = High | WellnessCoach- |
| | Q5 Moderate | Alert | Depression. |
| | to | Self-solutions for negativity bias | LiveAndWork |
| | Extremely | Q2, Q3. Deficit impulsivity - stream | Well for Stress |
| | Severe | to Anxiety: | |
| | | Q4, Q5 . . . Impulsivity with moderate- | |
| | | severe anxiety and low depression | |
| | | features. | |
| | | Q2, Q4, Q5 suggest following | |
| | | treatment solutions (carried through | |
| | | to confirmation from 5 to 8, in Tables | |
| | | D, E F). | |
| | | b. Medication. No indication of need | |
| | | for compound. SSRI. | |
| | | c. Adjunct CBT once positive drug | |
| | | response improved | |
| | | Go to Q6. Wellness Anxiety 11 | |
| | | (Ref B1-B6, B24, B25, B15, A2, A3) | |
| | Q4 | “Wellness Anxiety 12” | High Alert |
| | Mild/Normal | Q1. Deficit Negativity Bias = High | WellnessCoach- |
| | Q5 | Alert | Depression, |
| | Mild/Normal | Self-solutions for negativity bias | LiveAndWork |
| | | Q2, Q3. Deficit impulsivity - stream | Well for Stress |
| | | to Anxiety | |
| | | Q4, Q5. Impulsivity with low | |
| | | depression and low anxiety features. | |
| | | Q2, Q4, Q5 suggest following | |
| | | treatment solutions (carried through | |
| | | to confirmation from 5 to 8, in Tables | |
| | | D, E F). | |
| | | Inconsistency between markers and | |
| | | experienced mood. Screen for other | |
| | | potential contributing factors; a. | |
| | | personality disorder, b. organic | |
| | | cause, c. other medication effects. | |
| | | Self-solutions for deficit negativity | |
| | | bias | |
| | | Go to Q6. Wellness Anxiety 12 | |
| | | (Ref B1-B6, B15, B7, C1) | |

It would be appreciated that other general cognitive susceptibility markers (for example attention-concentration, memory, executive function) can also be assessed. By way of example only, this assessment can be summarised in the following table.

| | Q6. Other | | |
|---|---|---|---|
| | General | | |
| | Cognitive | | |
| | Markers: | | |
| | Memory, | | |
| | Executive | | |
| | Function, | | |
| | Information | | |
| | Processing | | |
| | Efficiency | | |
| | and/or | Additional Solutions for cognitive | Text in Report |
| Wellness | Attention- | dysfunction and confirmation of work | (Accumulated rules |
| Depression | Concentration | incapacity indicated | with addition of Q6.) |
| Wellness | Deficit on | Q6. Impulsivity with cognitive deficit - | Work incapacity |
| Anxiety | at least one | indicates work incapacity for ‘planning’ and | |
| 1 & 2 | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction |
| | | Adjunct CBT for negativity bias and mood, | Adjunct CBT |
| | | given severity of presentation, especially once | following cognitive |
| | | cognitive deficits have improved. | improvement |
| | | Q2 to Q6. Indicators confirm High Alert - | Medical referral. |
| | | monitor within 6 weeks. Medical referral for | Monitor within 6 |
| | | medication. | weeks |
| | | Report Button rationale: Combined markers | BUTTON: Markers |
| | | consistent with Anxiety with marked | consistent with |
| | | Impulsivity and marked Cognitive dysfunction. | Anxious Mood YES |
| | | (Ref B12, B7 | Consistent with |
| | | A1, B8-B11, A2, A3, B21) | Experienced Mood |
| | | | YES |
| | Borderline | Q6. Impulsivity with cognitive dysfunction - | Work incapacity |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication . . . | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction. | Consistent with |
| | | (Ref B12, B7 | Experienced Mood |
| | | A2, A3, B21) | YES |
| | Average/ | Q6. Impulsivity w/o cognitive dysfunction - | Work incapacity, |
| | Superior on | indicates Work incapacity, especially for | especially ‘monitoring’ |
| | all markers | ‘monitoring’ settings | settings. |
| | | Consider | |
| | | Adjunct CBT given severity of presentation. | Adjunct CBT |
| | | Absence of cognitive dysfunction: Screen for | Screen for other |
| | | other potential contributors to response | potential contributors |
| | | slowing: organic/other medications. | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Slowing and absence of cognitive dysfunction. | Anxious Mood YES |
| | | (Ref B12, A2, A3, C1, B21) | Consistent with |
| | | | Experienced Mood |
| | | | YES |
| Wellness | Deficit on | Q6. Impulsivity with cognitive deficit - | Work incapacity, |
| Anxiety 3 | at least one | indicates work incapacity for ‘planning’ and | |
| | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction. |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Impulsivity and marked Cognitive dysfunction. | Anxious Mood YES |
| | | (Ref B12, B7, A1, B8-B11, A2, A3, B21) | Consistent with |
| | | | Experienced Mood |
| | | | YES |
| | Borderline | Q6. Impulsivity with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Adjunct CBT given severity of presentation, | Adjunct CBT |
| | | especially cognitive deficits have improved. | following cognitive |
| | | | improvement |
| | | Q2 to Q6. Indicators confirm High Alert - | Medical referral. |
| | | monitor within 6 weeks. Medical referral for | Monitor within 6 |
| | | medication . . . | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction. | Consistent with |
| | | (Ref B12, B7, A2, A3, B21) | Experienced Mood |
| | | | YES |
| | Average/ | Q6. Impulsivity w/o cognitive dysfunction - | Work incapacity, |
| | Superior | indicates Work incapacity, especially for | especially ‘monitoring’ |
| | | ‘monitoring’ settings | settings, |
| | | Consider | |
| | | Adjunct CBT given severity of presentation | Adjunct CBT |
| | | Absence of cognitive dysfunction: Screen for | Screen for other |
| | | other potential contributors to response | potential contributors |
| | | slowing: organic/other medications. | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Slowing and absence of cognitive dysfunction. | Anxious Mood YES |
| | | (Ref B12, A2,A3, C1, B21) | Consistent with |
| | | | Experienced Mood |
| | | | YES |
| Wellness | Deficit on | Q6. Impulsivity with cognitive deficit - | Work incapacity, |
| Anxiety 4 | at least one | indicates work incapacity for ‘planning’ and | |
| | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and marked Cognitive | Anxious Mood YES. |
| | | dysfunction., but | Consistent with |
| | | inconsistent with experienced mood. | Experienced Mood |
| | | Screen for other potential contributors to | NO. |
| | | cognitive susceptibility markers: organic/other | Screen for other |
| | | medications. | potential contributors |
| | | (Ref B12, B7, A1, B8-B11, B21, C1) | to cognitive |
| | | | susceptibility markers. |
| | Borderline | Q6. Impulsivity with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction, but inconsistent with experienced | Consistent with |
| | | mood. | Experienced Mood |
| | | Screen for other potential contributors to | NO. |
| | | cognitive susceptibility markers | Screen for other |
| | | (Ref B12, B7, B21, C1) | potential contributors |
| | | | to cognitive |
| | | | susceptibility markers. |
| | Average/ | Q6. Impulsivity w/o cognitive dysfunction - | Work incapacity, |
| | Superior | indicates Work incapacity, especially for | especially ‘manual’ |
| | | ‘manual’ settings | settings |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction, but inconsistent with experienced | Consistent with |
| | | mood. | Experienced Mood |
| | | Screen for other potential contributors to | NO. |
| | | cognitive susceptibility markers | Screen for other |
| | | (Ref B12, B21, C1) | potential contributors |
| | | | to negativity bias and |
| | | | impulsivity. |
| Wellness | Deficit on | Q6. Impulsivity with cognitive deficit - | Work incapacity |
| Anxiety 5 | at least one | indicates work incapacity for ‘planning’ and | |
| & 6 | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction |
| | | Adjunct CBT for negativity bias and mood, | Adjunct CBT |
| | | given severity of presentation, especially once | following cognitive |
| | | cognitive deficits have improved. | improvement |
| | | Q2 to Q6. Indicators confirm High Alert - | Medical referral. |
| | | monitor within 6 weeks. Medical referral for | Monitor within 6 |
| | | medication. | weeks |
| | | Report Button rationale: Combined markers | BUTTON: Markers |
| | | consistent with Anxiety with marked | consistent with |
| | | Impulsivity and marked Cognitive dysfunction. | Anxious Mood YES |
| | | (Ref B12, B7, A1, B8-B11, A2, A3, B21) | Consistent with |
| | | | Experienced Mood |
| | | | YES |
| | Borderline | Q6. Impulsivity with cognitive dysfunction - | Work incapacity |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication. | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction. | Consistent with |
| | | (Ref B12, B7, A2, A3, B21) | Experienced Mood |
| | | | YES |
| | Average/ | Q6. Impulsivity w/o cognitive dysfunction - | Work incapacity, |
| | Superior | indicates Work incapacity, especially for | especially ‘monitoring’ |
| | | ‘monitoring’ settings | settings. |
| | | Consider | |
| | | Adjunct CBT given severity of presentation. | Adjunct CBT |
| | | Absence of cognitive dysfunction: Screen for | Screen for other |
| | | other potential contributors to response | potential contributors |
| | | slowing: organic/other medications. | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Slowing and absence of cognitive dysfunction. | Anxious Mood YES |
| | | (Ref B12, A2, A3, C1, B21) | Consistent with |
| | | | Experienced Mood |
| | | | YES |
| Wellness | Deficit on | Q6. Impulsivity with cognitive deficit - | Work incapacity, |
| Anxiety 7 | at least one | indicates work incapacity for ‘planning’ and | |
| | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction. |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Impulsivity and marked Cognitive dysfunction. | Anxious Mood YES |
| | | (Ref B12, B7, A1, B8-B11, A2, A3, B21) | Consistent with |
| | | | Experienced Mood |
| | | | YES |
| | Borderline | Q6. Impulsivity with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’, |
| | | Adjunct CBT given severity of presentation, | Adjunct CBT |
| | | especially cognitive deficits have improved. | following cognitive |
| | | | improvement |
| | | Q2 to Q6. Indicators confirm High Alert - | Medical referral. |
| | | monitor within 6 weeks. Medical referral for | Monitor within 6 |
| | | medication . . . | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction. | Consistent with |
| | | (Ref B12, B7 | Experienced Mood |
| | | A2, A3, B21) | YES |
| | Average/ | Q6. Impulsivity w/o cognitive dysfunction - | Work incapacity, |
| | Superior | indicates Work incapacity, especially for | especially ‘monitoring’ |
| | | ‘monitoring’ settings | settings, |
| | | Consider | |
| | | Adjunct CBT given severity of presentation | Adjunct CBT |
| | | Absence of cognitive dysfunction: Screen for | Screen for other |
| | | other potential contributors to response | potential contributors |
| | | slowing: organic/other medications. | to response slowing |
| | | Q2 to Q6. Indicators confirm High Alert - | Medical referral. |
| | | monitor within 6 weeks. Medical referral for | Monitor within 6 |
| | | medication | weeks |
| | | Report Button rationale: Combined markers | BUTTON: Markers |
| | | consistent with Anxious mood with marked | consistent with |
| | | Slowing and absence of cognitive dysfunction. | Anxious Mood YES |
| | | (Ref B12, A2, A3, C1, B21) | Consistent with |
| | | | Experienced Mood |
| | | | YES |
| Wellness | Deficit on | Q6. Impulsivity with cognitive deficit - | Work incapacity, |
| Anxiety 8 | at least one | indicates work incapacity for ‘planning’ and | |
| | marker | ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and marked Cognitive | Anxious Mood YES. |
| | | dysfunction., but | Consistent with |
| | | inconsistent with experienced mood. | Experienced Mood |
| | | Screen for other potential contributors to | NO. |
| | | cognitive susceptibility markers: organic/other | Screen for other |
| | | medications. | potential contributors |
| | | (Ref B12, B7, A1, B8-B11, B21, C1) | to cognitive |
| | | | susceptibility markers. |
| | Borderline | Q6. Impulsivity with cognitive dysfunction - | Work incapacity, |
| | on at least | indicates Work incapacity for ‘planning’ and | |
| | one marker, | ‘manual’ settings. | |
| | in absence | Consider | Self-solutions |
| | of Deficit | Self-solutions for cognitive dysfunction. | ‘cognitive gym’ |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction, but inconsistent with experienced | Consistent with |
| | | mood. | Experienced Mood |
| | | Screen for other potential contributors to | NO. |
| | | cognitive susceptibility markers | Screen for other |
| | | (Ref B12, B7, B21, C1 | potential contributors |
| | | | to cognitive |
| | | | susceptibility markers. |
| | Average/ | Q6. Impulsivity w/o cognitive dysfunction - | Work incapacity, |
| | Superior | indicates Work incapacity, especially for | especially ‘manual’ |
| | | ‘manual’ settings | settings |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with marked | consistent with |
| | | Impulsivity and moderate Cognitive | Anxious Mood YES |
| | | dysfunction, but inconsistent with experienced | Consistent with |
| | | mood. | Experienced Mood |
| | | Screen for other potential contributors to | NO. |
| | | cognitive susceptibility markers | Screen for other |
| | | (Ref B12, B21, C1) | potential contributors |
| | | | to negativity bias and |
| | | | impulsivity. |
| Wellness | Deficit on | Q6. Borderline impulsivity with cognitive | Work incapacity, |
| Anxiety 9 | at least one | deficit - indicates work incapacity. | |
| & 10 | marker | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction, |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Anxious mood with marked | consistent with |
| | | Cognitive dysfunction. | Anxious Mood YES |
| | | (Ref B12, B7, A1, B8-B11, A2, A3, B21) | Consistent with |
| | | | Experienced Mood |
| | | | YES. |
| | Borderline | Q6. Borderline impulsivity with moderate | Work incapacity, |
| | on at least | cognitive deficit - indicates work incapacity. | |
| | one marker, | Consider | Self-solutions |
| | in absence | Self-solutions for cognitive dysfunction. | ‘cognitive gym’. |
| | of Deficit | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation . . . | weeks |
| | | Report Button rationale: Combined markers | BUTTON: Markers |
| | | consistent with Anxious mood with moderate | consistent with |
| | | Cognitive dysfunction. | Anxious Mood YES |
| | | (Ref B12, B7 | Consistent with |
| | | A2, A3, B21) | Experienced Mood |
| | | | YES |
| | Average/ | Q6. Borderline impulsivity w/o cognitive | |
| | Superior | dysfunction - no confirmation of work | |
| | | incapacity. | |
| | | Screen for other potential contributors to | Screen for other |
| | | negativity bias: life events, personality | potential contributors |
| | | | to negativity bias |
| | | Q2 to Q6. Indicators confirm High Alert - | Medical referral. |
| | | monitor within 6 weeks. Medical referral for | Monitor within 8-12 |
| | | evaluation . . . | weeks |
| | | Report Button rationale: Combined markers | BUTTON: Markers |
| | | consistent with risk for Anxious mood with | consistent with risk for |
| | | absence of cognitive dysfunction. | Anxious Mood YES |
| | | (Ref B12, C1, B21) | Consistent with |
| | | | Experienced Mood |
| | | | YES |
| Wellness | Deficit on | Q6. Borderline impulsivity with cognitive | Work incapacity, |
| Depression | at least one | deficit - indicates work incapacity. | |
| 11 | marker | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction, |
| | | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation | weeks |
| | | Report Button rationale: Combined markers | BUTTON: Markers |
| | | consistent with Anxious mood with marked | consistent with |
| | | Cognitive dysfunction. | Anxious Mood YES |
| | | (Ref B12, B7, A1, B8-B11, A2, A3, B21) | Consistent with |
| | | | Experienced Mood |
| | | | YES. |
| | Borderline | Q6. Borderline impulsivity with moderate | Work incapacity, |
| | on at least | cognitive deficit - indicates work incapacity. | |
| | one marker, | Consider | Self-solutions |
| | in absence | Self-solutions for cognitive dysfunction. | ‘cognitive gym’. |
| | of Deficit | Adjunct CBT given severity of presentation, | Adjunct CBT |
| | | especially once cognitive deficits have | following cognitive |
| | | improved. | improvement |
| | | Q2 to Q6. Indicators confirm High Alert - | Medical referral. |
| | | monitor within 6 weeks. Medical referral for | Monitor within 6 |
| | | evaluation . . . | weeks |
| | | Report Button rationale: Combined markers | BUTTON: Markers |
| | | consistent with Anxious mood with moderate | consistent with |
| | | Cognitive dysfunction. | Anxious Mood YES |
| | | (Ref B12, B7, A2, A3, B21) | Consistent with |
| | | | Experienced Mood |
| | | | YES |
| | Average/ | Q6. Borderline impulsivity w/o cognitive | |
| | Superior | dysfunction - no confirmation of work | |
| | | incapacity. | |
| | | Screen for other potential contributors to | Screen for other |
| | | negativity bias: life events, personality | potential contributors |
| | | | to negativity bias |
| | | Q2 to Q6. Indicators confirm High Alert - | Medical referral. |
| | | monitor within 6 weeks. Medical referral for | Monitor within 8-12 |
| | | evaluation . . . | weeks |
| | | Report Button rationale: Combined markers | BUTTON: Markers |
| | | consistent with risk for Anxious mood with | consistent with risk for |
| | | absence of cognitive dysfunction. | Anxious Mood YES |
| | | (Ref B12, C1, B21) | Consistent with |
| | | | Experienced Mood |
| | | | YES |
| Wellness | Deficit on | Q6. Borderline impulsivity with cognitive | Work incapacity, |
| Depression | at least one | deficit - indicates work incapacity for | |
| 12 | marker | ‘planning’ and ‘manual’ settings. | |
| | | Consider | Self-solutions |
| | | Self-solutions for cognitive dysfunction. | ‘cognitive gym’, |
| | | Augmentation for cognitive dysfunction, given | Augmentation for |
| | | severity. | cognitive dysfunction |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with some | consistent with |
| | | Impulsivity and marked Cognitive | Anxious Mood YES. |
| | | dysfunction., but | Consistent with |
| | | inconsistent with experienced mood. | Experienced Mood |
| | | Screen for other potential contributors to | NO. |
| | | cognitive susceptibility markers: organic/other | Screen for other |
| | | medications. | potential contributors |
| | | (Ref B12, B7, A1, B8-B11, B21, C1) | to cognitive |
| | | | susceptibility markers. |
| | Borderline | Q6. Borderline impulsivity with moderate | Work incapacity |
| | on at least | cognitive dysfunction - indicates Work | |
| | one marker, | incapacity | |
| | in absence | Consider | Self-solutions |
| | of Deficit | Self-solutions for cognitive dysfunction. | ‘cognitive gym’ |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with borderline | consistent with |
| | | Impulsivity and moderate Cognitive | Anxious Mood YES |
| | | dysfunction, but inconsistent with experienced | Consistent with |
| | | mood. | Experienced Mood |
| | | Screen for other potential contributors to | NO. |
| | | cognitive susceptibility markers. | Screen for other |
| | | (Ref B12, B7, B21, C1) | potential contributors |
| | | | to cognitive |
| | | | susceptibility markers. |
| | Average/ | Q6. Borderline impulsivity without cognitive | Work incapacity for |
| | Superior | deficit - indicates work incapacity for | ‘monitoring’ settings |
| | | ‘monitoring’ settings | |
| | | Consider | |
| | | Q2 to Q6. Indicators confirm High Alert - | Medical referral. |
| | | monitor within 6 weeks. Medical referral for | Monitor within 6 |
| | | medication/screening. | weeks |
| | | Report Button rationale: Combined markers | BUTTON: Markers |
| | | consistent with Anxious mood with some | consistent with |
| | | Impulsivity and no Cognitive dysfunction., but | Anxious Mood YES. |
| | | inconsistent with experienced mood. | Consistent with |
| | | Screen for other potential contributors to | Experienced Mood |
| | | cognitive susceptibility markers: organic/other | NO. |
| | | medications. | Screen for other |
| | | (Ref B12, A1, B8-B11, B21, C1) | potential contributors |
| | | | to cognitive |
| | | | susceptibility markers. |

Confirmation from Emotion Recognition marker can be assessed. By way of example this assessment can be summarised in the following table.

| | Q7. | | |
|---|---|---|---|
| | Emotion | | |
| Wellness | Recognition | | Text in Report |
| Depression | Marker | Supporting indicators | (Add rules for Q7.) |
| Wellness | Deficit | Q7. Specific slowing of Negative emotion, | SSRI |
| Anxiety | | especially fear, anger. | |
| 1 & 2 | | Support for a. SSRI,. Go to Q8 | |
| | | (Ref B17, B18, B19) | |
| | Borderline | Q7. Specific slowing of Negative emotion, | SSRI |
| | | especially fear, anger. | |
| | | Consistent with a. SSRI,. Go to Q8 | |
| | | (Ref B17, B18, B19) | |
| | Average/ | Go to Q8. | |
| | Superior | | |
| Wellness | Deficit | Q7. Specific slowing of Negative emotion, | SSRI |
| Anxiety 3 | | especially fear, anger. | |
| | | Support for a. SSRI,. Go to Q8 | |
| | | (Ref B17, B18, B29) | |
| | Borderline | Q7. Specific slowing of Negative emotion, | SSRI |
| | | especially fear, anger. | |
| | | Consistent with a. SSRI,. Go to Q8 | |
| | | (Ref B17, B18, B19) | |
| | Average/ | Go to Q8 | |
| | Superior | | |
| Wellness | Deficit | Go to Q8 | |
| Anxiety 4 | | | |
| | Borderline | Go to Q8 | |
| | Average/ | Go to Q8 | |
| | Superior | | |
| Wellness | Deficit | Q7. Specific slowing of Negative emotion, | SSRI |
| Anxiety | | especially fear, anger. | |
| 5 & 6 | | Support for a. SSRI,. Go to Q8 | |
| | | (Ref B17, B18, B19) | |
| | Borderline | Q7. Specific slowing of Negative emotion, | SSRI |
| | | especially fear, anger. | |
| | | Consistent with a. SSRI,. Go to Q8 | |
| | | (Ref B17, B18, B19) | |
| | Average/ | Go to Q8. | |
| | Superior | | |
| Wellness | Deficit | Q7. Specific slowing of Negative emotion, | SSRI |
| Anxiety 7 | | especially fear, anger. | |
| | | Support for a. SSRI,. Go to Q8 | |
| | | (Ref B17, B18, B29) | |
| | Borderline | Q7. Specific slowing of Negative emotion, | SSRI |
| | | especially fear, anger. | |
| | | Consistent with a. SSRI,. Go to Q8 | |
| | | (Ref B17, B18, B19) | |
| | Average/ | Go to Q8 | |
| | Superior | | |
| Wellness | Deficit | Go to Q8 | |
| Anxiety 8 | | | |
| | Borderline | Go to Q8 | |
| | Average/ | Go to Q8 | |
| | Superior | | |
| Wellness | Deficit | Go to Q8 | |
| Anxiety | | | |
| 9 & 10 | | | |
| | Borderline | Go to Q8 | |
| | Average/ | Go to Q8 | |
| | Superior | | |
| Wellness | Deficit | Go to Q8 | |
| Anxiety | | | |
| 11 | | | |
| | Borderline | Go to Q8 | |
| | Average/ | Go to Q8 | |
| | Superior | | |
| Wellness | Deficit to | Go to Q8 | |
| Anxiety | Average/ | | |
| 12 | Superior | | |

Other social cognitive markers and substance use can be assessed. By way of example this assessment can be summarised in the following table.

| | Q8. | | | |
|---|---|---|---|---|
| | Other Social | | | |
| | Cognitive | | | |
| | Markers | Q9. | | Text in Report* |
| Wellness | (Emotional | Substance | | (Add from rules for |
| Depression | Resilience/Sociability) | Use | Additional Solutions indicated | Q8. and Q9.) |
| Wellness | Deficit on | Alcohol | Q8. Self-solutions for Social | Social Skills |
| Depression | one or more | | Cognition deficit | LiveAndWorkWell |
| 1 to 12 | | | Q9. Harmful Drinking. Self- | Alcohol |
| | | | Solutions plus Referral for Alcohol | Alcohol service |
| | | | service | referral |
| | | | (Ref B7, B22, B23) | |
| | | Other Drug | Q8. Self-solutions for Social | Social Skills |
| | | | Cognition deficit | Drug service referral |
| | | | Q9. Harmful Drug taking. Referral | |
| | | | for Drug service | |
| | | | (Ref B7, B22, B23) | |
| | | No | Q8. Self-solutions for Social | Social Skills |
| | | | Cognition deficit | |
| | | | (Ref B7) | |
| | No Deficit | Alcohol | Q9. Harmful Drinking. Self- | LiveAndWorkWell |
| | | | Solutions plus Referral for Alcohol | Alcohol |
| | | | service | Alcohol service |
| | | | (Ref B22, B23) | referral |
| | | Other Drug | 8. Harmful Drug taking. Referral | Drug service referral |
| | | | for Drug service | |
| | | | (Ref B22, B23) | |
| | | No | | |

It can be appropriate to report alcohol or other drugs if answering YES to harmful levels as defined by particular queries.

This reaches the termination of the particular branch of enquiry for this example embodiment.

It would be appreciated that (referring to FIG. 4), the level of negative bias is assessed to define branches associated with negative bias is in deficit 410, negative bias is borderline 411 and negative bias is in average and/or superior 412.

### REFERENCES

Any discussion of the following documents throughout the specification should in no way be considered as an admission that such background material is widely known or forms part of common general knowledge in the field.

In an embodiment, evidence was classified according to an accepted hierarchy of evidence that was adapted from the US Agency for Healthcare Policy and Research Classification and UK National Health Service National Institute for Clinical Excellence (NICE) guidelines. These guideline can be summarized in Table 1 and form a hierarchy of evidence and reference grading scheme. References outlined below were graded according to this table in categories A to D on the basis of the level of associated evidence (refer to the table below).

| Level | Type of evidence | Grade | Evidence |
|---|---|---|---|
| I | Evidence obtained from a single | A | At least one randomised controlled |
| | randomised controlled trial or a | | trial as part of a body of literature of |
| | meta-analysis of randomised | | overall good quality and consistency |
| | controlled trials | | addressing the specific |
| | | | recommendation (evidence level I) |
| | | | without extrapolation. Includes Brain |
| | | | Resource trials |
| IIa | Evidence obtained from at least one | B | Well-conducted clinical studies but |
| | well-designed controlled study | | no randomised clinical trials on the |
| | without randomisation | | topic of recommendation (evidence |
| | | | levels II or III); or extrapolated from |
| | | | level I evidence. Includes Brain |
| | | | Resource studies |
| IIb | Evidence obtained from at least one | | Includes internal analyses from Brain |
| | other well-designed quasi- | | resource international database |
| | experimental study | | |
| III | Evidence obtained from well- | | Includes internal analyses from Brain |
| | designed non-experimental | | resource international database, |
| | descriptive studies, such as | | presented as technical reports. |
| | comparative studies, correlation | | |
| | studies and case studies | | |
| IV | Evidence obtained from expert | C | Expert committee reports or opinions |
| | committee reports or opinions and/or | | and/or clinical experiences of |
| | clinical experiences of respected | | respected authorities (evidence level |
| | authorities | | IV). This grading indicates that |
| | | | directly applicable clinical studies of |
| | | | good quality are absent or not readily |
| | | | available. |
| | | D | Recommended good practice based |
| | | | on Guideline Development Group |
| | | | (GPP) with reported guidelines, |
| | | | including from the American |
| | | | Psychiatric Association and NHS |
| | | | NICE guidelines |

The following references are graded into categories A to D (as defined by the above table), but should in no way be considered as an admission that such references are widely known or forms part of common general knowledge in the field.

### Evidence A

Augmentation versus CBT. Evidence for focus on augmentation when cognitive dysfunction is moderate-severe is provided by:
[A1]. Thase M E, Friedman E S, Biggs M M. Cognitive Therapy Versus Medication in Augmentation and Switch Strategies as Second-Step Treatments: A STAR*D Report. Am J Psychiatry 2007, 164:739-752

Evidence for focus on CBT can be particularly successful for prevention of relapse once there has been a positive drug response. CBT may be more effective than interpersonal psychotherapy when depression is severe in particular. This evidence is provided by:
[A2] Fava G A, Rafanelli C, Grandi S, Conti S, Belluardo P. Prevention of Recurrent Depression With Cognitive Behavioral Therapy. Arch Gen Psychiatry. 1998; 55:816-820
[A3] Luty S E, Carter J D, McKenzie J M, Rae A M, Frampton C M, Mulder R T, Joyce P R. Randomised controlled trial of interpersonal psychotherapy and cognitive-behavioural therapy for depression. British Journal of Psychiatry, 2007; 190:496-502

Evidence for focus on

Treatment streaming using emotion indicators
[A4]. Harmer C J, Shelley N C, Cowen P J, Goodwin G M. Increased Positive Versus Negative Affective Perception and Memory in Healthy Volunteers Following Selective Serotonin and Norepinephrine Reuptake Inhibition, American J Psychiatry 2004; 161:1256-1263

### Evidence B (IIa)

It would be appreciated that negativity bias captures a distinct construct to symptom ratings of negative mood, which has been established in both normative and clinical groups. Negativity Bias can be used to predict functional outcomes, and is a contributor to degree of social function.
[B1]. Rowe D L, Cooper N, Liddell B J, Clark C R & Williams L M. (2007). Brain structure and function correlates of general and social cognition. Journal of Integrative Neuroscience, 6, 35-74.
[B2]. Williams L M, Whitford T J, Flynn G, Wong W, Liddell B J, Silverstein S, Galletly C, Harris A W, Gordon E. (2008). General and social cognition in first episode schizophrenia: dentification of separable factors and prediction of functional outcome using the IntegNeuro test battery, Schizophrenia Research, 99; 182-191

### Negativity Bias

[B3]. Open label trial—Brain Resource collaborative trial of biomarkers in depression. Which found Negativity bias significantly related to HAM-D score in Depression with systematic, linear relationship (0.75sd reduction in negativity bias with each HAMD groups defined as severe, moderate and mild). But, overlap only partial (r=0.387), since Negativity bias captures the comparatively stable construct of negative cognitive set and functional aspects of negative emotion in addition to experiential ones.

Higher Negativity Bias in those defined as high risk for Depression; top 15% in normative database, presenting with
[B4]. Williams L M, Mathersul D, Kemp A H et al. Identifying general and social cognitive susceptibility markers of risk for syndromal depression and anxiety. Behav. Research & Therapy (under review)

Negativity Bias as an innate and fundamental trait, evolutionary determination. Corresponding brain function support for this concept of negativity bias
[B25]. Cacioppo J T and Berntson G G (1994). Relationship between attitudes and evaluative space: A critical review, with emphasis on the separability of positive and negative substrates. Psychological Bulletin, 115, 401-423.
[B26]. Smith N K Cacioppo J T Larsen J T and Chartrand T L. (2003). May I have your attention, please: Electrocortical responses to positive and negative stimuli. Neuropsychologia, 41, 171-183.

Complementary evidence from experimental studies in the depression literature, including prospective evidence for importance of negativity bias in identifying risk for depression.
[B5]. Alloy L B, Abramson L Y, Fancis E L. Do negative cognitive styles confer vulnerability to depression? Current Directions in Psychological Science, 1999, 8 (4): 128-132.
[B6]. Alloy L B, Abramson L Y, Whitehouse W G, et al. Prospective incidence of first onsets and recurrences of depression in individuals at high and low cognitive risk for depression. J Abnormal Psychology 2006; 115:145-56.

Wellbeing and lifestyle factors included together with CBT help focus on building up resilience of positive function, as a complement to the focus of CBT on dealing with negative thinking/function.
[B7]. Fava G A, Rafanelli C, Cazzaro M, Conti S, Grandi S. Well-being therapy: a novel psychotherapeutic approach for residual symptoms of affective disorders. Psychological Medicine. 1998; 28:475-480.

See also A2.

Augmentation for cognitive symptoms (and for fatigue). Review of research, including case information
[B8]. Fava M. Augmentation and combination strategies in treatment-resistant depression. J Clin Psychiatry 2001; 62(suppl 18):4-11
[B9]. Fava M. Symptoms of Fatigue and Cognitive/Executive Dysfunction in Major Depressive Disorder Before and After Antidepressant Treatment. J Clinical Psychiatry, 2003, 64: 30-34.
[B10]. Fava M. Polypharmacy to Increase the Chances of Remission. Program and abstracts of the American Psychiatric Association 160th Annual Meeting; May 19-24, 2007; San Diego, Calif. Industry Symposium ISS04. Abstract 4D.
[B11]. Fava M, Covino J M. Augmentation/Combination Strategies for Residual Symptoms of Treatment Refractory Depression. In Workshop on Pharmacologic Management of Treatment-Refractory Depression Meeting of the American Psychiatric Association, 160th Annual Meeting; May 19-24, 2007, San Diego, Calif.

Cognitive Deficits contribute substantially to disability in Depression
[B12]. Naismight S L, Longley W A, Scott E M, HIckie I B. Disability in major depression related to self-rated and objectively-measured cognitive deficits: a preliminary study. BMC Psychiatry 2007, 7:32

Psychomotor slowing distinguishes a severe form of Depression (melancholia) which has been related to a biological disposition, including dysregulation of HPA axis
[B13]. Open label trial—Brain Resource collaborative trial of biomarkers in depression. Psychomotor slowing significantly higher in severe depression with melancholia symptoms present
[B14]. Meador-Woodruff, J., Greden, J. F., Grunhaus, L., Haskett, R. F., 1990. Severity of depression and hypothalamic-pituitary-adrenal axis dysregulation: identification of contributing factors. Acta Psychiatrica Scandinavica 81: 364-371.
[B15]. Austin M-P, Mitchell, P, Goodwin G M. Cognitive deficits in depression. British Journal of Psychiatry, 2001, 178: 200-206.

Compound medications needed for severe depression, especially with psychomotor slowing
[B16]. Taylor B P, Bruder G E, Stewart J W. (2006). Psychomotor Slowing as a Predictor of Fluoxetine Nonresponse in Depressed Outpatients. American Journal of Psychiatry, 2006, 163: 73-78

Treatment streaming using emotion indicators
[B17]. Venn, H. R., Watson, S., Gallagher, P., Young, A. H. Facial expression perception: an objective outcome measure for treatment studies in mood disorders?. International Journal of Neuropsychopharmacology, 2006, 9(2), 229-245.

Indicates facial emotion indicators are sensitive to treatment response
[B18]. Dannlowski U, Kersting A, Donges U-S, Lalee-Mentzel J, Arolt V, Suslow W. Masked facial affect priming is associated with therapy response in clinical depression. Eur Arch Psychiatry Clin Neurosci, 2006, 256: 215-221
[B19]. Open label trial—Brain Resource collaborative trial of biomarkers in depression. Emotion recognition RT for sadness (especially for those with response slowing) and fear/anger (for those without response slowing but with impulsivity and higher anxiety) enhanced prediction of treatment response to SNRI and SSRI respectively by 26%

Indication that there may be reduced controlled (explicit) emotion processing, with enhanced automatic (implicit) emotion processing.
[B20]. Matthews, G. & Southall, A. (1991). Depression and the processing of emotional stimuli: A study of semantic priming, Cognitive Therapy and Research, 15 (4): 283-302.

Combination of cognitive susceptibility markers which define major depression across studies to date
[B21]. Hasler, G., Drevets, W. C., Manji, H. K., Charney, D. S. (2004).

Discovering endophenotypes for major depression.
Neuropsychopharmacology, 29(10), 1765-1781.

### Evidence B (IIb)

Substance Use. Qualitative review of on-line solutions
[B22]. Copeland J & Martin G. Web-based interventions for substance use disorders: A qualitative review. Journal of Substance Abuse Treatment, (2004, 26, 109-116
[B23]. Linke S, Murry E, Butler C, Wallace P. Internet-Based Interactive Health Intervention for the Promotion of Sensible Drinking: Patterns of Use and Potential Impact on Members of the General Public. Journal of Medical Internet Research, 2007, 9, e10

### Evidence B (III)

Evidence that Negativity Bias scores provide the best ‘alert’ for risk of psychopathology, across mental disorders, with particularly pronounced deficits (two fold greater) in depression and anxiety.
[B24]. Brain Resource ‘personalized medicine’ report prepared for FDA. 2006.

### Evidence C

DSM guidelines for screening for medical conditions/other physical contributors
[C1]. Lopez Ibor J J, Frances A, Jones C. Dysthymic disorder: a comparison of DSMIV and ICD-10 and issues in differential diagnosis. Acta Psychiatrica Scandanavica 1994, 89: 12-18

### VARIATIONS

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing”, “computing”, calculating”, “determining”, “applying”, “deriving” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computer system” or a “computing machine” or a “computing platform” may include one or more processors.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It would be appreciated that, some of the embodiments are described herein as a method or combination of elements of a method that can be implemented by one or more processors of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the computer system comprising one or more processors operates as a standalone device or may be configured, e.g., networked to other processor(s), in a networked deployment. The one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Although the invention has been described with reference to specific examples it will be appreciated by those skilled in the art that the invention may be embodied in many other forms.

The claims defining the invention are as follows:

1. A method for rule based healthcare for use in the treatment of a patient, said method comprises the steps of:
(a) providing a storage means for storing data indicative of a plurality of decision states;
(b) presenting at least one query associated with a decision state;
(c) receiving a corresponding at least one response to said at least one query;
(d) comparing said response to a plurality of predefined responses ranges for selecting a new query associated with a new decision state;
(e) transitioning to the new decision state; and
(f) repeating steps (b) through (e) until a terminating decision state is reached.

2. A method according to claim 1 wherein data indicative of a plurality of decision states is in the form of a decision tree.

3. A method according to any one of the preceding claims, further comprising the step of outputting data indicative of a treatment associated with the final decision state.

4. A method according to any one of the preceding claims wherein step (e) further includes outputting data indicative of a treatment associated with that decision state.

5. A method according to any one of the preceding claims wherein said method is for the treatment of depression or anxiety in said patient.

6. A method according to claim 5 wherein said queries include the assessment:
Negativity;
Response;
Impulsivity;
Experienced Depression;
Experienced Anxiety and/or stress;
Cognitive Dysfunction;
Emotion Recognition;
Social Cognition; and
Substance Use.

7. A method of rule based healthcare for use in the treatment of a patient, wherein a predetermined treatment is selected in association with responses to a plurality of predefined queries, wherein said responses define a selected permutation and associated said treatment.

8. A method of rule based healthcare for use in the treatment of a patient, substantially as herein described with reference to any one of the embodiments of the invention illustrated in the accompanying drawings and/or examples.

9. A system for quantitative behavioural health management of a patient, said system comprising a processor adapted to perform the method according to any one of to the preceding claims.

10. A system for quantitative behavioural health management of a patient, said system comprising:
(a) a memory device including a data indicative of a plurality of predefined decision states;
(b) output means for displaying a query associated with a current decision state;
(c) input means for entering response data indicative of a predetermined plurality responses;
(d) a processor for transition to a new decision state according to said response data and said current decision state; wherein said processing means outputs a predetermined treatment associated with a final decision state.

11. A system according to claim 10 wherein data indicative of a plurality of decision states is in the form of a decision tree.

12. A system according to any one of claims 10 to 11, wherein said processor is further adapted to output data indicative of a predetermined treatment associated with that decision state.

13. A system according to any one of claims 10 to 12, wherein said system is for the treatment of depression or anxiety in said patient.

14. A system according to any one of claims 10 to 13, wherein said system is accessible to an operator via the World Wide Web over the Internet, and/or via another electronic medium using another protocol.

15. A system for quantitative behavioural health management of a patient, substantially as herein described with reference to any one of the embodiments of the invention illustrated in the accompanying drawings and/or examples.
